(19) United States
(12) Patent Application Publication
(10) Pub. No.: US 2014/0115446 A1
(43) Pub. Date: Apr. 24, 2014

(54) Content Control Tools for a Document Authoring Application

(71) Applicant: APPLE INC., Cupertino, CA (US)

(72) Inventors: David M. Hall, Brush Prairie, WA (US); Allison M. Styer, San Francisco, CA (US); Christopher E. Rudolph, Vancouver, WA (US); Charles J. Migos, Millbrae, CA (US); Martin J. Murrett, Portland, OR (US); Markus Hagele, San Francisco, CA (US)

(73) Assignee: APPLE INC., Cupertino, CA (US)

(21) Appl. No.: 13/657,835

(22) Filed: Oct. 22, 2012

(51) Int. Cl. G06F 17/21

(52) U.S. Cl. CPC G06F 17/211
USPC 715/243; 715/255

(57) ABSTRACT

Some embodiments provide a non-transitory machine-readable medium that stores a document authoring application which when executed by at least one processing unit provides a graphical user interface (“GUI”) for the document authoring application. The GUI includes a display area for displaying a document being authored. The GUI also includes a document authoring tool for adding to the document a floatable content control. The floatable content control includes (1) a content display area for displaying content specified for the floatable content control and (2) a selectable user interface item (UI) that when selected causes the document authoring application to display the content display area. The floatable content control for display by a document viewing application such that the document viewing application displays the specified content through the content display area when the document viewing application receives a selection of the UI item.

### BACKGROUND

A variety of tools are available today that allow users to create and edit electronic documents. For instance, a user may create and edit an electronic document using any number of different word processing applications, such as Microsoft Word®, Apple Pages®, Corel WordPerfect®, etc.

Word processing applications typically provide a number of tools for editing documents or for facilitating the editing of documents. For example, some word processing applications provide tools to format text (e.g., font, font size, spacing, margins, etc.), insert different types of content (e.g., tables, images, hyperlinks, etc.), check grammar (e.g., spelling, punctuation, etc.), etc.

### BRIEF SUMMARY

For a document authoring application, some embodiments of the invention provide a novel content control tool for adding superimposable content controls to a document. In some embodiments, the content control tool includes a selectable user interface (UI) item that a user selects to insert a superimposable content control into the document being authored. A superimposable content control of some embodiments includes (1) a superimposable display area through which content specified for the superimposable content control is displayed and (2) a selectable image for triggering the display of the superimposable display area.

In some embodiments, once the superimposable content control is created and added to the document, the user specifies content for the superimposable content control. For instance, in some embodiments, the user adds content to a content layout (also referred to as a “canvas”) that is displayed through the content control's superimposable display area in order to specify content for the superimposable content control. In some embodiments, a content layout is a description of an arrangement of content in a defined area. Examples of content that the user may specify for the superimposable content control include textual content, image content, audio content, video content, and/or any other type of media content. In addition, the document authoring application of some embodiments allows the user to replace the superimposable content control's default image with a different image to better represent the content control's content.

The document authoring application of some embodiments provides a publishing functionality that generates a published version of the document (e.g., a non-editable version of the document) for subsequent viewing. As such, when the user is finished authoring the document, the user in some such embodiments publishes the document using the document authoring application in order to generate a published version of the document.

In some embodiments, a document viewing application is utilized to view the published document. When a user is viewing a portion of the published document that includes the superimposable content control, the document viewing application of some embodiments displays only the superimposable content control's selectable image. To view the superimposable content control's content, the user selects the superimposable content control's image, which causes the document viewing application of some embodiments to display the superimposable content control's display area by superimposing the display area over other content that the document viewing applications is displaying.

The document authoring application of some embodiments provides a novel content control tool for adding scrollable content controls to the document. The content control tool of some embodiments includes a selectable UI item that a user selects to insert a scrollable content control into the document being authored. In some embodiments, the content control tool is also for adding superimposable content controls to the document. In other embodiments, the content control tool for adding scrollable content controls to the document and the content control tool for adding superimposable content controls to the document are separate tools.

In some embodiments, a scrollable content control includes (1) a content layout and (2) a display area for displaying the content control's content layout separate from other content in the document. The scrollable content control of some embodiments includes a scrolling feature that allows the user to adjust the portion of the content control's content layout that is displayed in the display area when the content layout cannot be displayed in the display area all at once.

After the scrollable content control is created and added to the document, the user specifies content for the content control, in some embodiments. For example, the user in some embodiments adds content to the scrollable content control's display area in order to specify content for the content control. Examples of content that the user may specify for the scrollable content control include textual content, image content, audio content, video content, and/or any other type of media content.

As noted above, in some embodiments, the document authoring application provides a publishing functionality that generates a published version of the document for subsequent viewing. When the user is finished authoring the document, the user in some such embodiments publishes the document using the document authoring application in order to generate a published version of the document.

A document viewing application, as explained above, is used in some embodiments to view the published document. When a user is viewing a portion of the published document that includes the scrollable content control, the document viewing application of some embodiments displays the content specified for the scrollable content control in the content control's display area. When the scrollable content control's content cannot be displayed in its display area all at once, the document viewing application allows the user to adjust the portion of the content control's content that is displayed in the display area.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, Detailed Description and the Drawings is needed. Moreover, the claimed subject matters are not to be limited by the illustrative details in the Summary, Detailed Description and the Drawing, but rather are to be defined by the appended claims, because the claimed subject matters can be embodied in other specific forms without departing from the spirit of the subject matters.

### BRIEF DESCRIPTION OF THE DRAWINGS

The novel features of the invention are set forth in the appended claims. However, for purposes of explanation, several embodiments of the invention are set forth in the following figures.

FIG. 1 conceptually illustrates a graphical user interface (GUI) of a document authoring application of some embodiments that provides a content control tool for adding superimposable content controls to a document.

FIG. 2 conceptually illustrates the content control illustrated in FIG. 1 as presented by a document viewing application of some embodiments.

FIG. 3 conceptually illustrates a GUI of a document authoring application of some embodiments that provides a content control tool for adding scrollable content controls to a document.

FIG. 4 conceptually illustrates the content control illustrated in FIG. 3 as presented by a document viewing application of some embodiments.

FIG. 5 conceptually illustrates specifying an image for a superimposable content control according to some embodiments of the invention.

FIG. 6 conceptually illustrates a process of some embodiments for determining a location to display a superimposable display area of a superimposable content control.

FIGS. 7-12 conceptually illustrates several examples of a superimposable content control's image positioned at different locations of a document's page and the different locations at which the superimposable content control's display area is presented.

FIG. 13 conceptually illustrates adding media content to scrollable content control according to some embodiments of the invention.

FIG. 14 conceptually illustrates an automatic layout-resizing feature of a scrollable content control according to some embodiments of the invention.

FIG. 15 conceptually illustrates an example of resizing and moving a scrollable content control according to some embodiments of the invention.

FIG. 16 conceptually illustrates the scrollable content control illustrated in FIG. 15 as presented by a document viewing application of some embodiments.

FIG. 17 conceptually illustrates the scrollable content control illustrated in FIG. 15 as presented in a portrait-viewing mode by a document viewing application of some embodiments

FIG. 18 conceptually illustrates an example hierarchical data structure for representing a structured electronic document according to some embodiments of the invention.

FIG. 19 conceptually illustrates the software architecture of a document authoring application of some embodiments.

FIG. 20 is an example of an architecture of a mobile computing device.

FIG. 21 conceptually illustrates an electronic device with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

For a document authoring application, some embodiments of the invention provide a novel content control tool for adding superimposable content controls to a document. In some embodiments, the content control tool includes a selectable user interface (UI) item that a user selects to insert a superimposable content control into the document being authored. A superimposable content control of some embodiments includes (1) a superimposable display area through which content specified for the superimposable content control is displayed and (2) a selectable image for triggering the display of the superimposable display area. In this application, a superimposable content control may be referred to as a pop-over control or a pop-over content control.

A document, in some embodiments, includes digital documents, electronic documents, electronic books (e-books), etc. In some embodiments, the document is a structured electronic document that is organized according to a hierarchy of document elements and/or constructs. The document of some embodiments can include any number of different types of content (e.g., text, images, audio, video, etc.).

In some embodiments, once the superimposable content control is created and added to the document, the user specifies content for the superimposable content control. For instance, in some embodiments, the user adds content to a content layout (also referred to as a “canvas”) that is displayed through the content control's superimposable display area in order to specify content for the superimposable content control. In some embodiments, a content layout is a description of an arrangement of content in a defined area. Examples of content that the user may specify for the superimposable content control include textual content, image content, audio content, video content, and/or any other type of media content. In addition, the document authoring application of some embodiments allows the user to replace the superimposable content control's default image with a different image to better represent the content control's content.

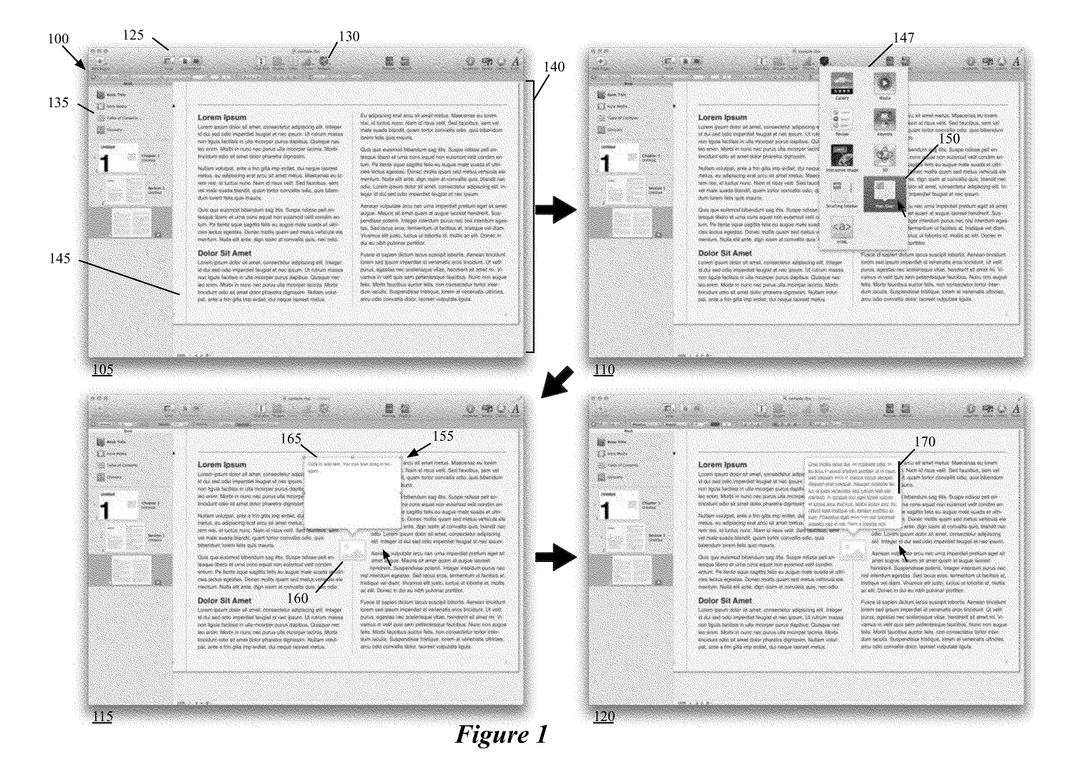

FIG. 1 conceptually illustrates a GUI 100 of a document authoring application of some embodiments that provides a content control tool for adding superimposable content controls to a document. Specifically, FIG. 1 illustrates the GUI 100 at four different stages 105-120 of creating a superimposable content control for a document 145 according to some embodiments of the invention.

As shown, the GUI 100 includes a toolbar 125, a side panel 135, and a display area 140. The toolbar 125 includes a selectable UI item 130 for displaying a menu of content controls as well as several other selectable user interface (UI) items for authoring or facilitating the authoring of the document. The side panel 135 includes two sections: a first section (the top section in this example) of links to different document elements and a second section (the bottom section in this example) that contains selectable thumbnail images of the chapters, sections, and/or pages of the document being edited. The display area 140 is for displaying a portion of the document that is editable.

The first stage 105 of the GUI 100 shows the document 145 open for a user to author. As shown, the document 145 includes a title, introductory media, table of contents, and glossary, as indicated by the top section of the side panel 135. In addition, the document includes one chapter, one section, and three pages, which is indicated by the selectable thumbnails in the bottom section of the side panel 135.

In addition, the first stage 105 shows the third page of the document 145 displayed in the display area 140. This is indicated by a highlighting of the section of the side panel 135 that includes the selectable thumbnail corresponding to the third page of the document 145.

The second stage 110 illustrates the GUI 100 after the user invoked the display of (e.g., opened) a menu 147 that includes several selectable UI items for inserting into the document 145 different content controls provided by the content control tool of some embodiments. Specifically, the user in this example invoked the menu 147 by selecting the UI item 130 using a cursor (e.g., by performing a cursor operation such as clicking a mouse button, tapping a touchpad, or touching the UI item 130 displayed on a touchscreen, etc.). As illustrated in the second stage 110, the menu 147 includes a selectable UI item 150 for adding to the document 145 a superimposable content control provided by the content control tool of some embodiments. The menu 147 also includes several other selectable UI items for adding to the document 145 other content controls provided by the content control tool in some embodiments.

In some embodiments, a content control is a construct that defines interactive content for a document. For instance, content specified for a superimposable content control of some embodiments is defined such that, when the content is displayed, the content is superimposed over other displayed content. As another example, content specified for a scrollable content control of some embodiments, which is described below, is defined such that the scrollable content control's content is scrollable when the size of the content layout is larger than the display area through which the content layout is displayed.

Interactive content, in some embodiments, is content that requires a user to provide input to a document viewing application through which the user viewing the content in order to cause the document viewing application to present and/or further present a portion of or the entire interactive content to the user. For instance, in some embodiments, a superimposable content control that is part of a document requires a user to provide input to a document viewing application through which the user viewing the document in order to cause the document viewing application to superimpose the content specified for the superimposable content control over the portion of the document that the user is viewing. As another example, a scrollable content control, which is described below, that is part of a document requires a user to provide input to a document viewing application through which the user viewing the document in order to cause the document viewing application to scroll the content with respect to the display area through which the content is displayed.

The second stage 110 also illustrates that the user is creating a superimposable content control for the document authoring application to add to the document 145. As shown in this stage, the user is creating a superimposable content control by selecting the UI item 150 using a cursor (e.g., by performing a cursor operation such as clicking a mouse button, tapping a touchpad, or touching the UI item 150 displayed on a touchscreen, etc.). The selection of the UI item 150 is indicated by a highlighting of the UI item 150.

The third stage 115 illustrates the GUI 100 after a superimposable content control 155 is added to the document 145. For this example, when the document authoring application receives the selection of the UI item 150, the document authoring application creates (e.g., instantiates) the superimposable content control 155 and automatically inserts the superimposable content control 155 into the document 145. As shown, the superimposable content control 155 includes a selectable image 160 (e.g., a thumbnail image) and a superimposable display area 165. In some embodiments, the image 160 is the default image that the document authoring application specifies for a superimposable content control when the superimposable content control is created and added to a document being authored. Different embodiments define different default images for a superimposable content control.

In some embodiments, as illustrated in the third stage 115, when the document authoring application adds the superimposable content control 155 to the document 145, the document authoring application positions the superimposable content control 155 so that the image 160 of the superimposable content control 155 at or near the center of the page that is displayed in the display area 140. The document authoring application of different embodiments adds superimposable content controls to a document differently. For example, in some embodiments, the document authoring application adds a superimposable content control to the portion of a document that is displayed at or near the center of the display area 140. As another example, the document authoring application of some embodiments allows the user of the application to select a location in the document to insert the superimposable content control.

The fourth stage 120 shows the GUI 100 after the user has specified content for the superimposable content control 155. For this example, the user has specified content for the superimposable content control 155 by selecting the display area 165 using the cursor (e.g., by performing a cursor operation such as double-clicking a mouse button, double-tapping a touchpad, or touching the display area 165 displayed on a touchscreen twice in quick succession, etc.) and providing text input (e.g., through a keyboard, a virtual keyboard displayed on a touchscreen, etc.) to the display area 165. When the document authoring application of some embodiments receives the selection of the display area 165, the document authoring application allows the user to specify content (e.g., add content, modify content, remove content, etc.) for the superimposable content control 155. In some embodiments, the document authoring application displays a content cursor (e.g., a text cursor, a caret, etc.) within the superimposable display area 165 to indicate to the user (1) that the user may add content to the superimposable display area 165 and (2) the location in the display area 165 at which content will be inserted.

In addition to specifying content for the superimposable content control 155, the document authoring application of some embodiments allows the user to specify the appearance and formatting of the content. For instance, the user may specify the type of font for text, the size of the font, the line spacing of the text, and/or any other attribute that relates to the appearance of textual content displayed in the superimposable display area 165. In some embodiments, the size of the content layout is larger than the size of the superimposable display area 165 itself. The document authoring application of some embodiments provides a scrolling feature that allows the user to move the content layout (e.g., scroll in a vertical direction, scroll in a horizontal direction, etc.) with respect to the superimposable display area 165 in order to adjust the portion of the content layout that is displayed in the superimposable display area 165. In this manner, the user may view the different portions of the superimposable content control 155's content layout since the content layout cannot be displayed all at once in the superimposable display area 165. In this example, the superimposable display area 165 includes a movable scroll indicator 170 for indicating (1) that content is scrollable in a vertical direction with respect to the superimposable display area 165 and (2) the location of the portion of the superimposable display area 165's content that is displayed in the superimposable display area 165 relative to the entire content layout.

The document authoring application of some embodiments provides a publishing functionality that generates a published version of the document for subsequent viewing. In some embodiments, the document authoring application of some embodiments sends the published document to a content distribution system for distributing, selling, etc. As such, when the user is finished authoring the document, the user in some embodiments publishes the document using the document authoring application in order to generate a published version of the document.

In some embodiments, the document authoring application publishes a document by generating a non-editable version of the document. The document authoring application of some embodiments generates the non-editable version of the document in a different format in order for users to differentiate between the original document and the non-editable version of the document. While the published documents mentioned above prevent users from editing the contents of published documents, the document viewing application of some embodiments allows users to annotate the published documents. For instance, a user may bookmarks sections of the document for quick viewing at a later time, create notes associated with different sections of the documents, highlight content in the document, etc.

In some embodiments, a document viewing application is utilized to view the published document. When a user is viewing a portion of the published document that includes the superimposable content control, the document viewing application of some embodiments displays only the superimposable content control's selectable image. To view the superimposable content control's content, the user selects the superimposable content control's image, which causes the document viewing application of some embodiments to display the superimposable content control's display area by superimposing the display area over other content that the document viewing applications is displaying.

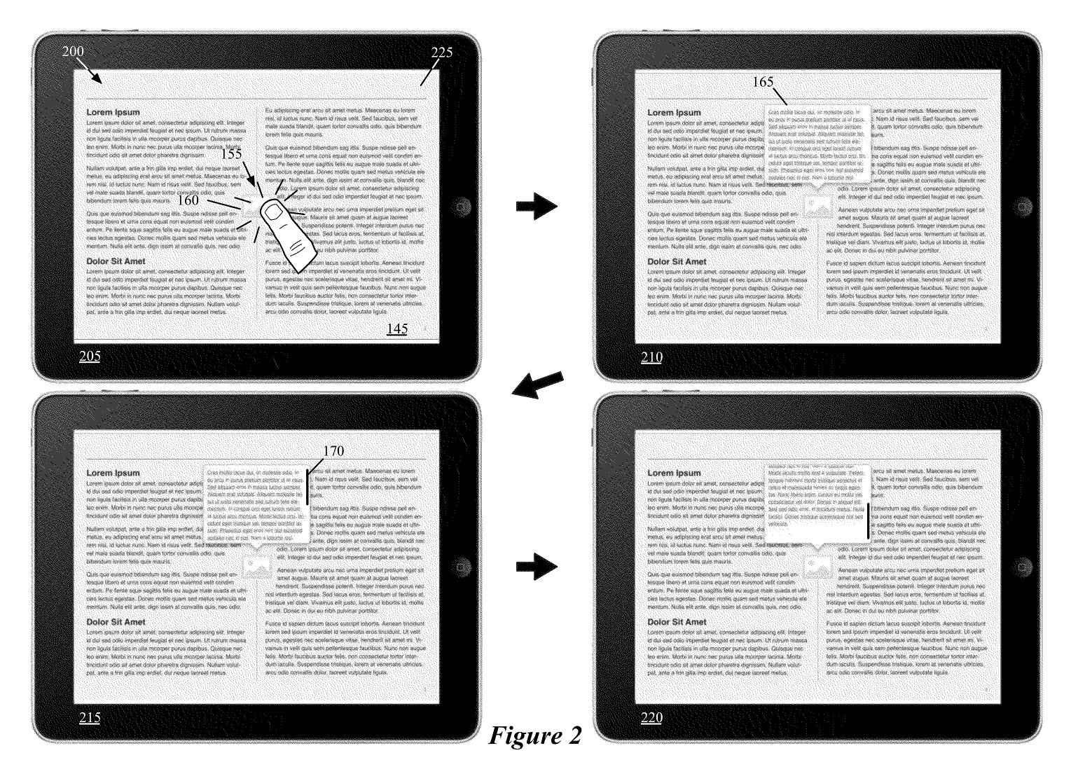

FIG. 2 conceptually illustrates the content control 155 illustrated in FIG. 1 as presented by a document viewing application of some embodiments. In particular, FIG. 2 illustrates a GUI 200 provided by the document viewing application of some embodiments at four different stages 205-220 of viewing the contents of the superimposable content control 155 of the document 145 illustrated in FIG. 1. As shown, the GUI 200 includes a display area 225 for displaying a portion of the document 145. As mentioned above, the document that the document viewing application uses is a published version of the document 145.

The first stage 205 illustrates the GUI 200 displaying a portion of the document 145 that includes the superimposable content control 155. As shown, the document viewing application is displaying only the selectable image 160 in the first stage 205. In addition, the first stage 205 illustrates a user selecting the image 160 by touching a finger on the image 160 displayed on the touchscreen. When the document viewing application receives the selection of the image 160, the document viewing application of some embodiments displays the superimposable display area 165 of the content control 155 by superimposing the superimposable display area 165 over other content displayed in the display area 225.

The second first stage 210 illustrates the GUI 200 after the image 160 has been selected to invoke the display of the superimposable display area 165 of the content control 155. As shown, the superimposable display area 165 is displayed over the other content displayed in the display area 225.

The third stage 215 illustrates the GUI 200 as the user begins scrolling the content displayed in the superimposable display area 165. In this example, the user is scrolling the content in an upward direction by touching a finger on the display area 165 displayed on the touchscreen and dragging the finger in an upward direction across the touchscreen. In some embodiments, when the document viewing application receives a touch input through the touchscreen of a location within the superimposable display area 165, the document viewing application displays the movable scroll indicator 170. As shown, the scroll indicator 170 is indicating (1) that content is scrollable in a vertical direction with respect to the superimposable display area 165 and (2) the portion of the superimposable display area 165's content that is displayed is at or near the beginning of the content layout.

The fourth stage 220 shows the GUI 200 after the user scrolled to the end or near the end of the superimposable display area 165's content. Similarly, the user in this example scrolled the content in an upward direction by touching a finger on the display area 165 displayed on the touchscreen and dragging the finger in an upward direction across the touchscreen. As illustrated, the scroll indicator 170 is indicating (1) that content is scrollable in a vertical direction with respect to the superimposable display area 165 and (2) the portion of the superimposable display area 165's content that is displayed is at or near the end of the content layout.

As illustrated by FIGS. 1 and 2, the superimposable content control provides a mechanism for optionally presenting additional content when viewing a particular portion of a document while maintaining the view of the particular portion of the document (e.g., without having to navigate to another portion or section of the document).

The document authoring application of some embodiments provides a novel content control tool for adding scrollable content controls to the document. The content control tool of some embodiments includes a selectable UI item that a user selects to insert a scrollable content control into the document being authored. In some embodiments, the content control tool is also for adding superimposable content controls to the document. In other embodiments, the content control tool for adding scrollable content controls to the document and the content control tool for adding superimposable content controls to the document are separate tools.

In some embodiments, a scrollable content control includes (1) a content layout and (2) a display area for displaying the content control's content layout separate from other content in the document. The scrollable content control of some embodiments includes a scrolling feature that allows the user to adjust the portion of the content control's content layout that is displayed in the display area when the content layout cannot be displayed in the display area all at once.

After the scrollable content control is created and added to the document, the user specifies content for the content control, in some embodiments. For example, the user in some embodiments adds content to the scrollable content control's display area in order to specify content for the content control. Examples of content that the user may specify for the scrollable content control include textual content, image content, audio content, video content, and/or any other type of media content.

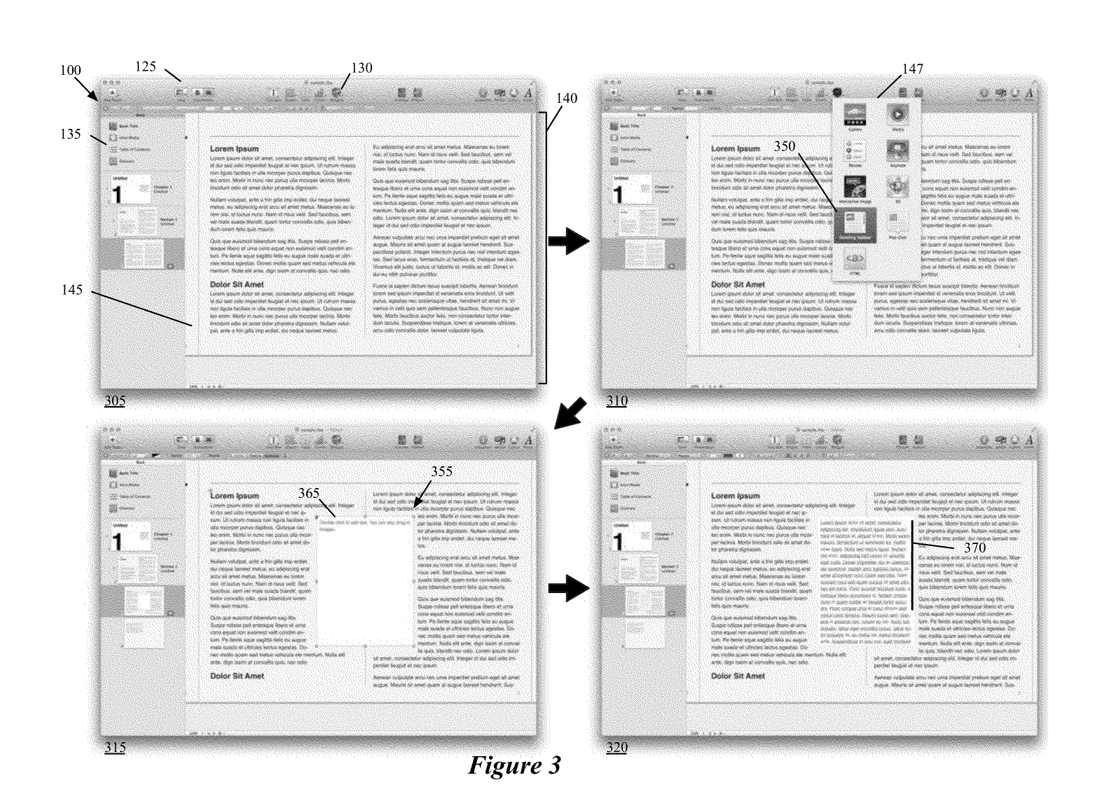

FIG. 3 conceptually illustrates the GUI 100 of a document authoring application of some embodiments that provides such a content control tool for adding scrollable content controls to a document. In particular, FIG. 3 illustrates the GUI 100 at four different stages 305-320 of creating a scrolling content control for the document 145 according to some embodiments of the invention.

The first stage 305 of the GUI 100 is similar to the first stage 105 described above by reference to FIG. 1. That is, the first stage 305 illustrates the document 145 open for a user to author and the third page of the document 145 is displayed in the display area 140.

The second stage 310 illustrates the GUI 100 after the user invoked the display of the menu 147 that includes several selectable UI items for inserting into the document 145 different content controls provided by the content control tool of some embodiments. Specifically, the user in this example invoked the menu 147 by selecting the UI item 130 using a cursor (e.g., by performing a cursor operation such as clicking a mouse button, tapping a touchpad, or touching a touchscreen, etc.). In addition, the second stage 310 shows that the menu 147 includes a selectable UI item 350 for adding to the document 145 a scrollable content control provided by the content control tool of some embodiments.

The second stage 310 also illustrates that the user is creating a scrollable content control for the document authoring application to add to the document 145. As illustrated, the user is creating a scrollable content control by selecting the UI item 350 using a cursor (e.g., by performing a cursor operation such as clicking a mouse button, tapping a touchpad, or touching a touchscreen, etc.). The selection of the UI item 350 is indicated by a highlighting of the UI item 350.

The third stage 315 illustrates the GUI 100 after a scrollable content control 355 is added to the document 145. In this example, when the document authoring application receives the selection of the UI item 350, the document authoring application creates (e.g., instantiates) the scrollable content control 355 and automatically inserts the scrollable content control 355 into the document 145. As shown, the scrollable content control 355 includes a display area 365 for displaying scrollable content. As illustrated in the third stage 315, when the document authoring application of some embodiments adds the scrollable content control 355 to the document 145, the document authoring application positions the scrollable content control 355 such that the display area 365 of the scrollable content control 355 at or near the center of the page that is displayed in the display area 140. The document authoring application of different embodiments adds scrollable content controls to a document differently. For example, in some embodiments, the document authoring application adds a scrollable content control to the portion of a document that is displayed at or near the center of the display area 140. As another example, the document authoring application of some embodiments allows the user of the application to select a location in the document to insert the scrollable content control.

The fourth stage 320 shows the GUI 100 after the user has specified content for the scrollable content control 355. In this example, the user has specified content for the scrollable content control 355 by selecting the display area 365 using the cursor (e.g., by performing a cursor operation such as double-clicking a mouse button, double-tapping a touchpad, or touching a touchscreen twice in quick succession, etc.) and providing text input (e.g., through a keyboard, a virtual keyboard displayed on a touchscreen, etc.) to the display area 365. When the document authoring application of some embodiments receives the selection of the display area 365, the document authoring application allows the user to specify content (e.g., add content, modify content, remove content, etc.) for the scrollable content control 355. In some embodiments, the document authoring application displays a content cursor (e.g., a text cursor, a caret, etc.) within the display area 365 to indicate to the user (1) that the user may add content to the display area 365 and (2) the location in the display area 365 at which content will be inserted.

In addition to specifying content for the scrollable content control 355, the document authoring application of some embodiments allows the user to specify the appearance and formatting of the content. For example, the user may specify the type of font of text, the size of the font, the line spacing of the text, and/or any other formatting of the text in the display area 365. In some embodiments, the size of the content layout in the display area 365 is larger than the size of the display area 365 itself. In some embodiments, the scrolling feature provided for the scrollable content control by the document authoring application allows the user to move content layout (e.g., scroll in a vertical direction, scroll in a horizontal direction, etc.) with respect to the display area 365 in order to adjust the portion of the content layout that is displayed in the display area 365. This way, the user may view the different portions of the scrollable content control 355's content as the content cannot be viewed all at once. In this example, the display area 365 includes a movable scroll indicator 370 for indicating (1) that content is scrollable in a vertical direction with respect to the display area 365 and (2) the location of the portion of the display area 365's content that is displayed in the display area 365 relative to the entire content layout.

As noted above, in some embodiments, the document authoring application provides a publishing functionality that generates a published version of the document for subsequent viewing. When the user is finished authoring the document, the user in some such embodiments publishes the document using the document authoring application in order to generate a published version of the document.

A document viewing application, as explained above, is used in some embodiments to view the published document. When a user is viewing a portion of the published document that includes the scrollable content control, the document viewing application of some embodiments displays the content specified for the scrollable content control in the content control's display area. When the scrollable content control's content cannot be displayed in its display area all at once, the document viewing application allows the user to adjust the portion of the content control's content that is displayed in the display area.

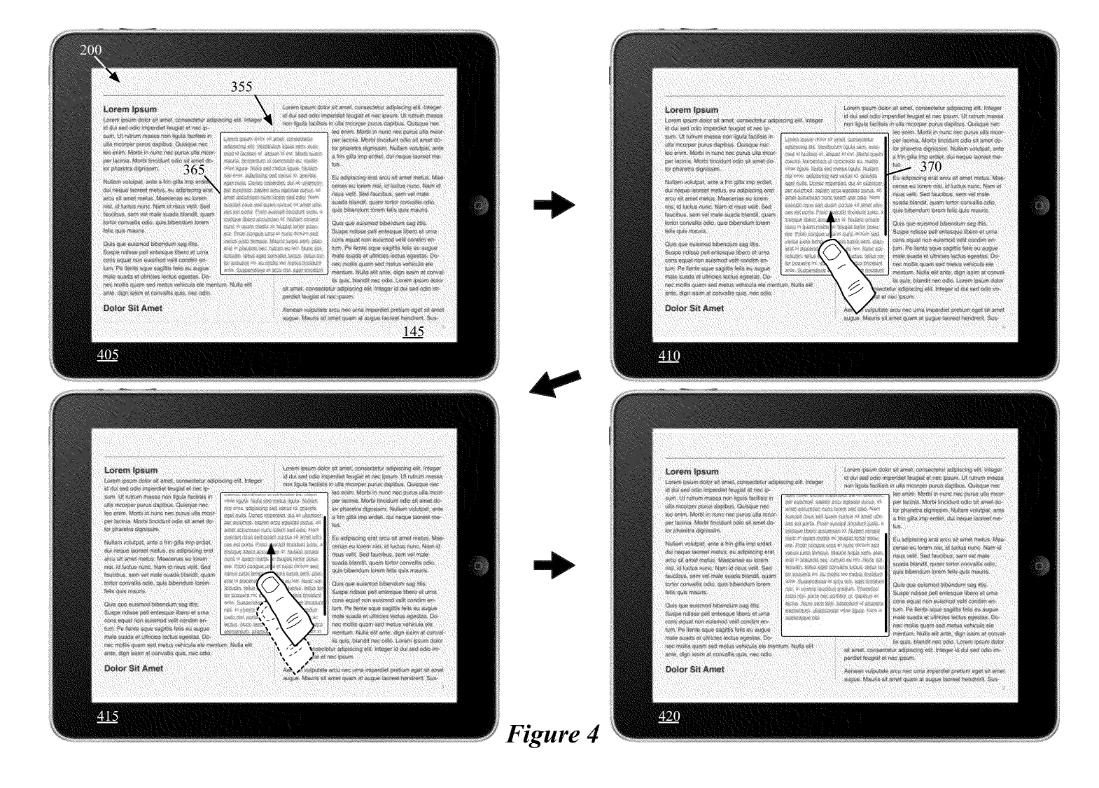

FIG. 4 conceptually illustrates the content control 355 illustrated in FIG. 3 as presented by a document viewing application of some embodiments. Specifically, FIG. 2 illustrates a GUI 200 provided by the document viewing application of some embodiments at four different stages 405-420 of viewing the content of the scrollable content control 355 of the document 145 illustrated in FIG. 1.

The first stage 405 illustrates the GUI 200 displaying a portion of the document 145 that includes the scrollable content control 355. As shown, the document viewing application is displaying the scrollable content control 355's display area 365 in the first stage 405.

The second stage 410 illustrates the GUI 200 as a user begins scrolling the content displayed in the display area 365. In this example, the user is scrolling the content in an upward direction by touching a finger on the display area 365 displayed on the touchscreen and dragging the finger in an upward direction across the touchscreen. In some embodiments, when the document viewing application receives a touch input through the touchscreen of a location within the display area 365, the document viewing application displays the movable scroll indicator 370. As shown, the scroll indicator 370 is indicating (1) that content is scrollable in a vertical direction with respect to the display area 365 and (2) the portion of the display area 365's content that is displayed is at or near the beginning of the content layout.

The third stage 415 the GUI 200 illustrates the user continuing to scroll the content through the display area 365. The user in this example continues scrolling the content in an upward direction by continuing to touch the finger on the touchscreen and dragging the finger in an upward direction across the touchscreen. As shown, the scroll indicator 370 is indicating (1) that the content layout is scrollable in a vertical direction with respect to the display area 365 and (2) the portion of the content layout that is displayed in the display area 365 is at or near the middle of the content layout.

The fourth stage 420 shows the GUI 200 after the user finished scrolling the content to the end or near the end of the display area 365. For this example, the user finished scrolling the content by lifting the finger off the touchscreen. As illustrated, the scroll indicator 370 is indicating (1) that content is scrollable in a vertical direction with respect to the display area 365 and (2) the portion of the content layout displayed in the display area 365's is at or near the end of the content layout.

Although the figures described above and below are discussed with respect to a particular tool (e.g., a tool for adding superimposable content controls, a tool for adding scrollable content controls, etc.) or type of content control (e.g., a superimposable content control, a scrollable content control, etc.), one of ordinary skill in the art will understand that the examples and/or features are also applicable to other tools and types content controls in some embodiments. For instance, the automatic layout-resizing feature described below for a scrollable content control may be a feature provided for the superimposable content controls by the document authoring application of some embodiments.

Several more detailed embodiments of the invention are described in the sections below. Section I conceptually describes details of superimposable content controls according to some embodiments of the invention. Next, Section II conceptually describes details of scrollable content controls according to some embodiments of the invention. Section III follows this with a description of a data structure for representing superimposable content controls and scrollable content controls according to some embodiments of the invention. Next, Section IV describes an example document authoring application of some embodiments. Finally, Section V describes several electronic systems that implement some embodiments of the invention.

### I. Superimposable Content Controls

As described above, in some embodiments, the document authoring application provides a content control tool for creating a superimposable content control, adding the superimposable content control to a document, and specifying content for the superimposable content control. This section will describe various aspects of the content control tool of some embodiments for superimposable content controls.

A. Specifying an Image

As noted above, in some embodiments, the document authoring application specifies the image 160 illustrated in FIG. 1 as the default image when the document authoring application creates and adds a superimposable content control to a document being authored. The document authoring application of some embodiments allows a user to specify an image to replace the superimposable content control's default image.

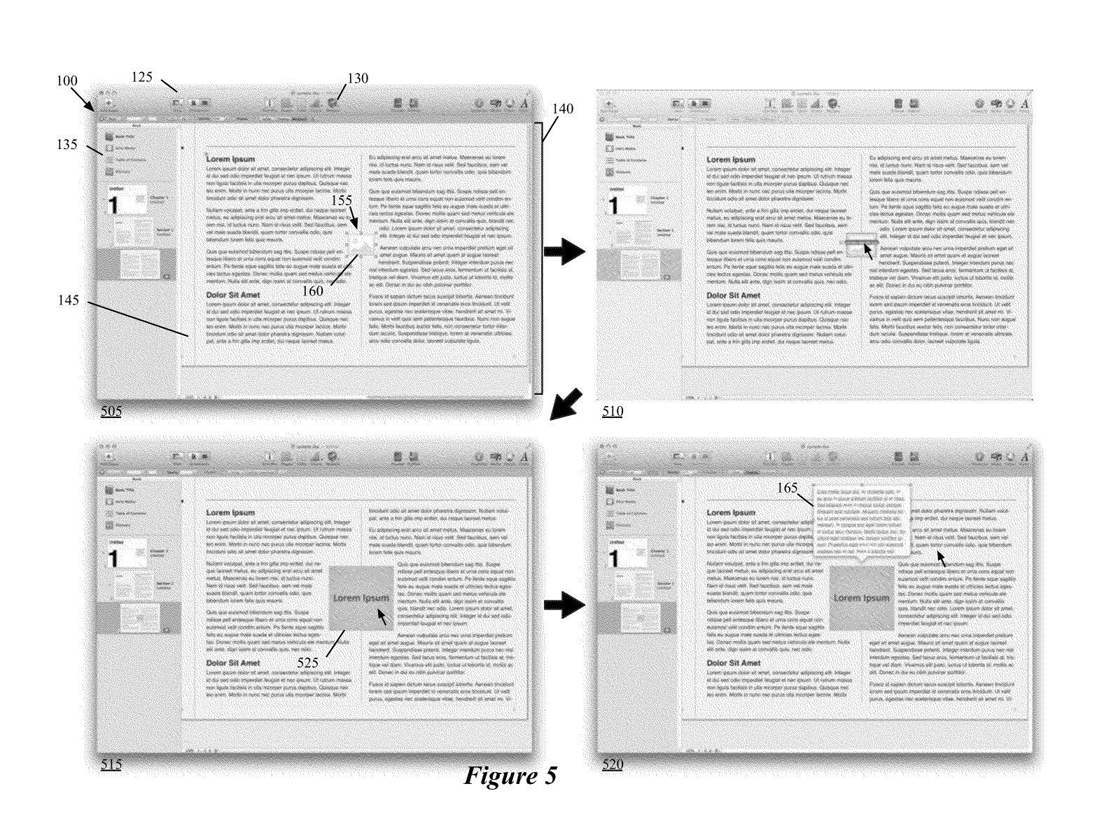

FIG. 5 conceptually illustrates an example of specifying an image for a superimposable content control according to some embodiments of the invention. Specifically, FIG. 5 illustrates the GUI 100 at four different stages 505-520 that show an example operation for replacing the default image 160 of the superimposable content control 155.

The first stage 505 shows that the GUI 100 is displaying the image 160 of the superimposable content control 155 while not displaying the content control 155's superimposable display area 165. In this example, the first stage 505 illustrates the GUI 100 after a user caused the superimposable display area 165 shown in the fourth stage 120 of FIG. 1 to close (i.e., no longer be displayed) by selecting with a cursor (e.g., by performing a cursor operation such as clicking a mouse button, tapping a touchpad, or touching a touchscreen, etc.) a location in the display area 140 other than a location within the superimposable display area 165. For this example, the user selected the image 160 do close the superimposable content control's display area 165.

In some embodiments, the document authoring application allows a user to adjust the size of a superimposable content control's image. For example, when the document authoring application of some embodiments receives a selection of the superimposable content control's image, the document authoring application presents (e.g., overlays) a set of adjustable UI controls (e.g., square-shaped adjustment handles) for adjusting the size of the image. Referring to FIG. 5 as an example, the first stage 505 illustrates the document authoring application of some embodiments overlaying a set of adjustable UI controls for adjusting the size of the superimposable content control's image 160. As illustrated in the first stage 505, an adjustable UI control is overlaid at each corner of the image 160 and an adjustable UI control is overlaid along each side of the image 160. In some embodiments, the user adjusts the size of the image 160 by selecting and moving an adjustable UI control (e.g., by clicking-and-holding a mouse button and dragging the mouse, tapping a touchpad and dragging across the touchpad, or touching with a finger the adjustable UI control displayed on a touchscreen and dragging the finger across the touchscreen) in order to adjust the size of the image 160 along a direction (e.g., up, down, left, right, diagonal, etc.).

The second stage 510 of the GUI 100 illustrates that the user is replacing the image 160 with a different image. For this example, the user has selected a graphical representation of an image (a jpg file in this example) in a folder structure (not shown in FIG. 5) of an operating system on which the document authoring application is operating using a cursor (e.g., by performing a drag-and-drop cursor operation such as clicking and holding a mouse button, touching and dragging across a touchscreen, etc.) and placing a graphical representation of the image over the image 160.

The third stage 515 shows the GUI 100 after the document authoring application has replaced the image 160 of the superimposable content control 155 with a selectable image 525. When the document authoring application of some embodiments receives the selected graphical representation of the image through the image 160, the document authoring application replaces the image 160 with the selected image. In some embodiments, the document authoring application reduces the size of the selected image when the image exceeds a defined dimension or set of dimensions (e.g., width, height, etc.) while maintaining the aspect ratio of the image. When the selected image does not meet a defined minimum dimension or set of dimensions, the document authoring application of some embodiments enlarges the size of selected image while maintaining the aspect ratio of the image.

The fourth stage 520 illustrates the GUI 100 after the document authoring application of some embodiments displaying the superimposable display area 165 of the superimposable content control 155 in the display area 140. In some embodiments, the document authoring application displays the superimposable display area 165 when the document authoring application receives a selection of the image 160 of the superimposable content control 155. In this example, the user selected the image 165 using a cursor (e.g., by performing a cursor operation such as clicking a mouse button, tapping a touchpad, or touching a touchscreen, etc.) in order to invoke the display of the superimposable content control 155's display area 165. When the superimposable display area 165 is displayed in the display area 140, the user may specify content (e.g., add content, modify content, remove content, etc.) for the superimposable content control 155 in a similar manner as that described above by reference to FIG. 1 (e.g., selecting the display area 165 and providing text input to the display area 165).

The document authoring application of some embodiments allows a user to adjust the size of the superimposable display area of a superimposable content control. For instance, in some embodiments, the document authoring application presents (e.g., overlays) a set of adjustable UI controls (e.g., square-shaped adjustment handles) for adjusting the size of the superimposable content control's display area when the document authoring application receives a selection of the superimposable content control's display area. Referring to FIG. 5 as an example, the fourth stage 520 illustrates the document authoring application of some embodiments presenting a set of adjustable UI controls for adjusting the size of the superimposable display area 165 of the superimposable content control. As shown, an adjustable UI control is overlaid at each corner of the display area 166 and an adjustable UI control is overlaid along each side of the display area 165.

FIG. 5 illustrates an example of replacing the default image of a superimposable content control. In some embodiments, the document authoring application allows the user to specify an image for the superimposable content control any number of times. The document authoring application of some embodiments also allows the user to set the superimposable content control's image back to the default image (e.g., the image 160).

In addition, FIG. 5 shows one technique for specifying an image for a superimposable content control. The document authoring application of different embodiments provide additional and/or other techniques for specifying an image for a superimposable content control. For example, in some embodiments, the document authoring application allows the user to specify an image for a superimposable content control using a hotkey, a keystroke, a series of keystrokes, a combination of keystrokes, an option from a pull-down menu or a pop-up menu, etc.

B. Displaying a Superimposable Display Area

As described above by reference to FIG. 5, the document authoring application of some embodiments allows a user to invoke the display of a superimposable content control's display area so that the user can specify content for the superimposable content control. In some embodiments, the document authoring application automatically determines the location at which the superimposable display area of the superimposable content control is displayed in the document authoring application's display area (e.g., the display area 140) relative to the superimposable content control's image.

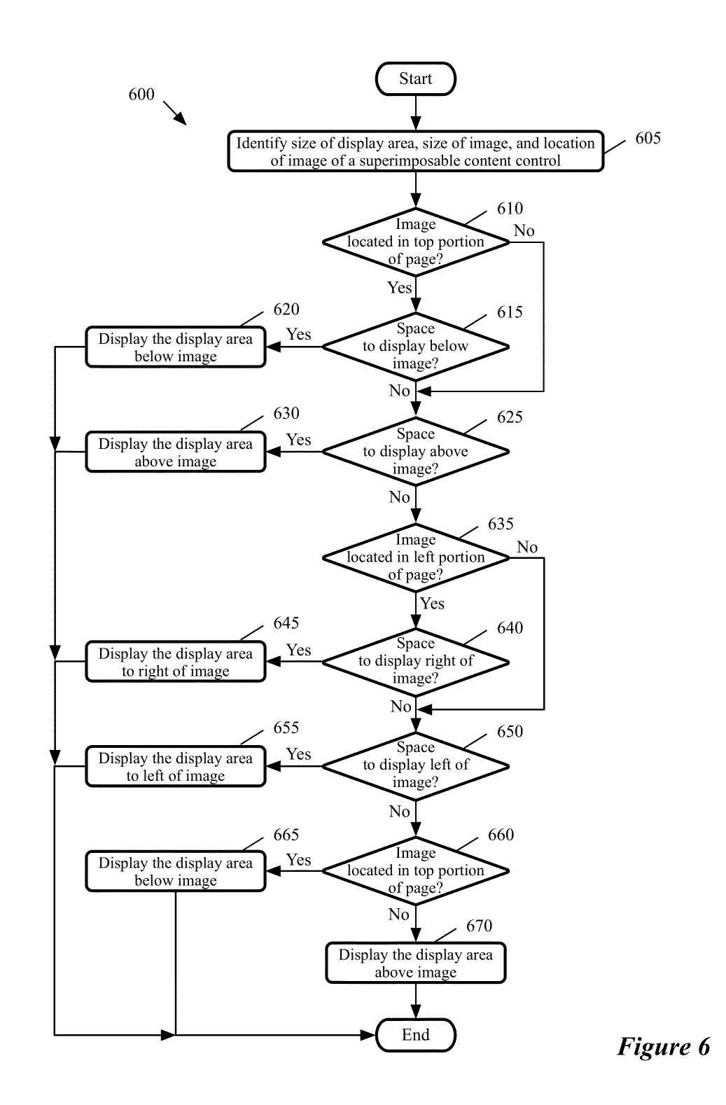

FIG. 6 conceptually illustrates a process of some embodiments for determining a location at which to display a superimposable display area of a superimposable content control. In some embodiments, the document authoring application described above and below by reference to FIGS. 1, 3, 5 and 7-12 performs the process 600 when the document authoring application receives input to invoke the display of a superimposable content control's display area (e.g., a selection of the image of the superimposable content control). The document viewing application of some embodiments performs the process 600 for determining a location at which to superimpose the display area of a superimposable content control over other content of a document that the document viewing application is displaying.

When the document authoring application described above and below by reference to FIGS. 1, 3, 5 and 7-12 receives input to adjust the size of the image of a superimposable content control or the size of the display area of the superimposable content control, the document authoring application of some embodiments performs the process 600 to determine a location at which to display the superimposable content control's display area based on the sizes of the superimposable content control's image and display area. The document authoring application of some such embodiments repeatedly performs the process 600 while the size of the image or display area of a superimposable content control is being adjusted in order to provide a real-time feedback of the layout of the image and display area according to the current size of the superimposable content control's image and display area.

Furthermore, the process 600 will be described by reference to FIGS. 7-12, which conceptually illustrates several examples of a superimposable content control's image positioned at different locations of a document's page and the different locations at which the superimposable content control's display area is presented. The process 600 starts by identifying (at 605) the size of the display area of a superimposable content control, the size of the image of the superimposable content control, and the location (e.g., x-coordinate and y-coordinate values) of the image with respect to a page of a document that includes the superimposable content control. In some embodiments, the process 600 identifies the information by accessing a data structure used to represent the superimposable content control. In some embodiments, the size of the display area and the size of the image are expressed in terms of pixel resolution (e.g., M×N pixels).

Next, the process 600 determines (at 610) whether the image is located in the top portion of the page in which the image is included. In some embodiments, the process 600 determines that the image is located in the top portion of the page when at least half of the image is positioned above a line that horizontally bisects the page. The process 600 of some embodiments uses additional and/or different methods for determining that the image is located in the top portion of the page.

When the process 600 determines that the image is not located in the top portion of the page, the process 600 proceeds to 625. When the process 600 determines that the image is located in the top portion of the page, the process 600 determines (at 615) whether space is available to display the display area of the superimposable content control below the image of the superimposable content control. Based on the size of the image, the size of the display area, and the size of the page, the process 600 of some embodiments determines that space is available to display the display area of the superimposable content control when the superimposable content control's display area is displayable between the bottom side of the superimposable content control's image and the bottom side of the page without overlapping the image and without intersecting the page.

If the process 600 of some embodiments determines that space is not available to display the display area below the image, the process 600 continues to 625. Otherwise, the process 600 displays (at 620) the display area of the superimposable content control below the superimposable content control's image and then the process 600 ends.

FIG. 7 conceptually illustrates an example of the document authoring application of some embodiments determining (e.g., by performing the process 600) to display the superimposable content control 155's display area 165 below the superimposable content control 155's image 160. As shown in FIG. 7, the image 160 is located in the top portion of a page of the document 145 (e.g., at least half of the image 160 is positioned above a line that horizontally bisects the page) that is displayed in the display area 140 and the display area 165 fits between the bottom side of the image 160 and the bottom side of the page.

At 625, the process 600 determines whether space is available to display the display area of the superimposable content control above the image of the superimposable content control. In some embodiments, the process 600 determines, based on the size of the image, the size of the display area, and the size of the page, that space is available to display the display area of the superimposable content control if the superimposable content control's display area is displayable between the top side of the superimposable content control's image and the top side of the page without overlapping the image and without intersecting the page.

When the process 600 determines that space is not available to display the display area above the image, the process 600 continues to 635. In some embodiments, when the process 600 determines that space is available to display the display area above the image, the process 600 displays (at 630) the display area of the superimposable content control below the superimposable content control's image and then the process 600 ends.

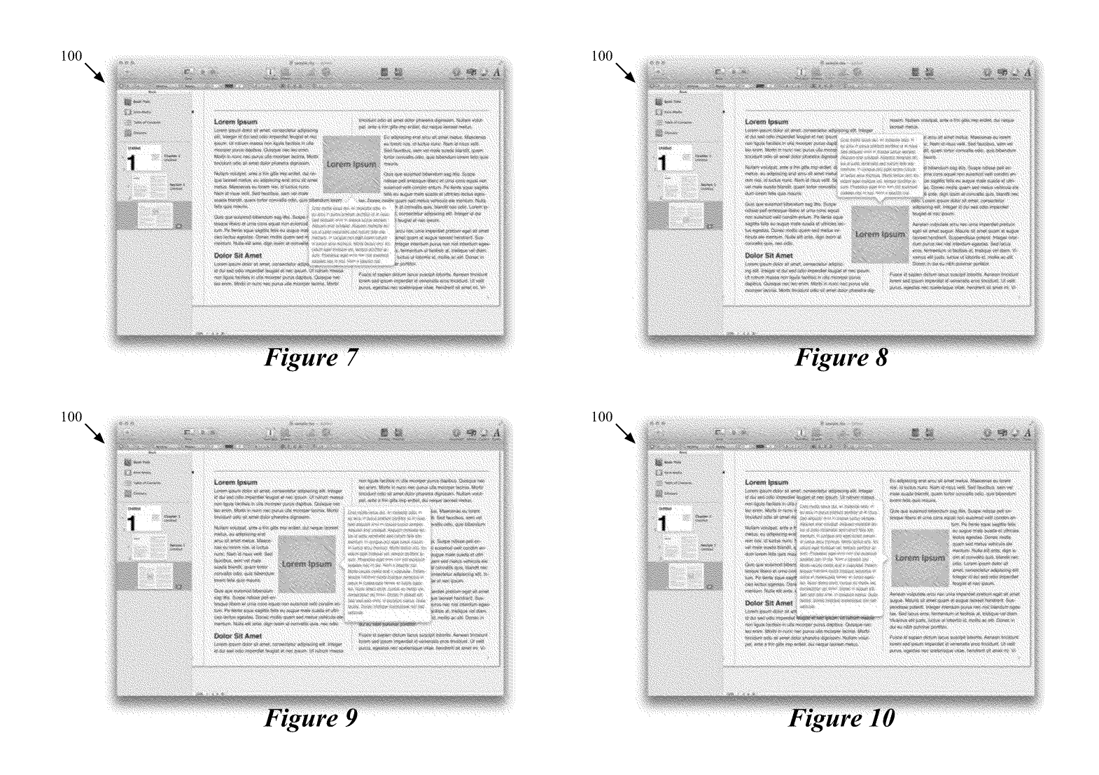

FIG. 8 conceptually illustrates an example of the document authoring application of some embodiments determining (e.g., by performing the process 600) to display the superimposable content control 155's display area 165 above the superimposable content control 155's image 160. In particular, FIG. 8 shows that the image 160 is located in the bottom portion of a page of the document 145 (e.g., at least half of the image 160 is positioned below a line that horizontally bisects the page) that is displayed in the display area 140 and the display area 165 fits between the top side of the image 160 and the top side of the page.

Next, the process 600 determines (at 635) whether the image is located in the left portion of the page. The process 600 of some embodiments determines that the image is located in the left portion of the page when at least half of the image is positioned to the left of a a line that vertically bisects the page. The process 600 of some embodiments uses additional and/or different methods for determining that the image is located in the left portion of the page.

If the process 600 determines that the image is not located in the left portion of the page, the process 600 proceeds to 650. Otherwise, the process 600 determines (at 640) whether space is available to display the display area of the superimposable content control to the right of the image of the superimposable content control. Based on the size of the image, the size of the display area, and the size of the page, the process 600 of some embodiments determines that space is available to display the display area of the superimposable content control when the superimposable content control's display area is displayable between the right side of the superimposable content control's image and the right side of the page without overlapping the image and without intersecting the page.

When the process 600 of some embodiments determines that space is not available to display the display area to the right of the image, the process 600 continues to 650. Otherwise, the process 600 displays (at 645) the display area of the superimposable content control to the right of the superimposable content control's image and then the process 600 ends.

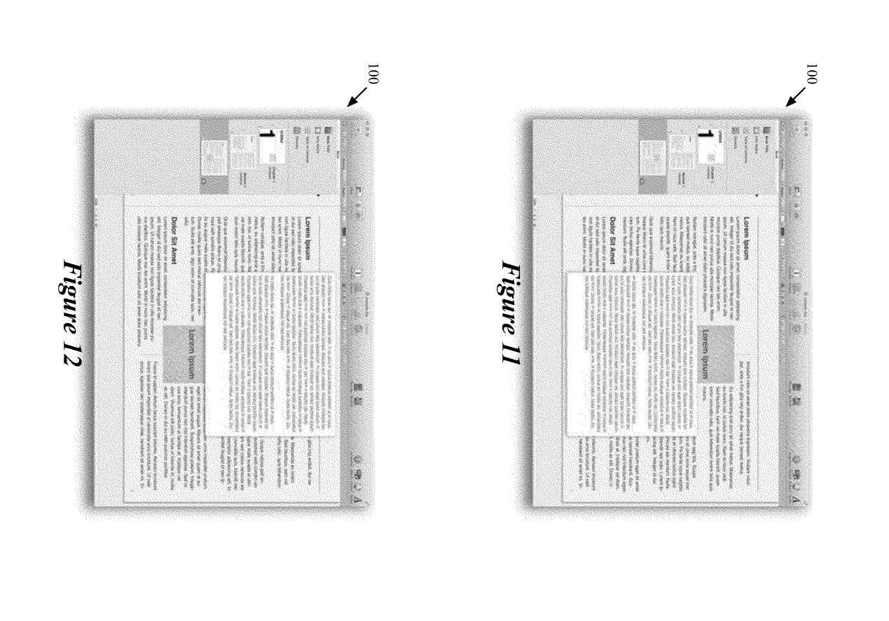

FIG. 9 conceptually illustrates an example of the document authoring application of some embodiments determining (e.g., by performing the process 600) to display the superimposable content control 155's display area 165 to the right of the superimposable content control 155's image 160. As shown in FIG. 9, the image 160 is located in the left portion of a page of the document 145 (e.g., at least half of the image 160 is positioned to the left of a line that vertically bisects the page) that is displayed in the display area 140 and the display area 165 fits between the right side of the image 160 and the right side of the page.

At 650, the process 600 determines whether space is available to display the display area of the superimposable content control to the left of the image of the superimposable content control. Based on the size of the image, the size of the display area, and the size of the page, the process 600 of some embodiments determines that space is available to display the display area of the superimposable content control when the superimposable content control's display area is displayable between the left side of the superimposable content control's image and the left side of the page without overlapping the image and without intersecting the page.

In some embodiments, when the process 600 determines that space is not available to display the display area to the left of the image, the process 600 continues to 660. Otherwise, the process 600 displays (at 655) the display area of the superimposable content control to the left of the superimposable content control's image and then the process 600 ends.

FIG. 10 conceptually illustrates an example of the document authoring application of some embodiments determining (e.g., by performing the process 600) to display the superimposable content control 155's display area 165 to the left of the superimposable content control 155's image 160. As illustrated in FIG. 10, the image 160 is located in the right portion of a page of the document 145 (e.g., at least half of the image 160 is positioned to the right of a line that vertically bisects the page) that is displayed in the display area 140 and the display area 165 fits between the left side of the image 160 and the left side of the page.

Next, the process 600 determines (at 660) whether the image is located in the top portion of the page. The process 600 of some embodiments determines that the image is located in the top portion of the page when at least half of the image is positioned above a line that horizontally bisects the page. In some embodiments, the process 600 uses additional and/or different methods for determining that the image is located in the top portion of the page.

If the process 600 determines that the image is located in the top portion of the page, the process 600 displays (at 665) the superimposable content control's display area below the image of the superimposable content control and then the process 600 ends. The process 600 of some embodiments displays the superimposable content control's display area above the image of the content control (e.g., the center of the display area is above the center of the image) and overlapping the image of the content control. In some embodiments, the process 600 displays the superimposable content control's display area without intersecting any of the sides of the page while, in other embodiments, the process 600 displays the superimposable content control's display area intersecting one or more sides of the page.

FIG. 11 conceptually illustrates an example of the document authoring application of some embodiments determining (e.g., by performing the process 600) to display the superimposable content control 155's display area 165 above the superimposable content control 155's image 160 and overlapping the image 160. As shown in FIG. 11, the image 160 is located in the top portion of a page of the document 145 (e.g., at least half of the image 160 is positioned above a line that horizontally bisects the page) that is displayed in the display area 140 and the display area 165 is larger than the display area 165 shown in FIGS. 7-10. In this example, the location of the image 160 in the page, the size of the display area 165, and the size of the page prevents the document authoring application from displaying the display area 165 below the image 160 without overlapping the image 160 nor intersecting any of the sides of the page. As such, the document authoring application displays the display area 165 above and overlapping the image 160 and without intersecting any of the sides of the page.

When the process 600 determines that the image is not located in the top portion of the page, the process 600 displays (at 665) the display area of the superimposable content control above the superimposable content control's image and then the process 600 ends. In some embodiments, the process 600 displays the superimposable content control's display area below the image of the content control (e.g., the center of the display area is below the center of the image) and overlapping the image of the content control. The process 600 of some embodiments displays the superimposable content control's display area without intersecting any of the sides of the page while, the process 600 of other embodiments displays the superimposable content control's display area intersecting one or more sides of the page.

FIG. 12 conceptually illustrates an example of the document authoring application of some embodiments determining (e.g., by performing the process 600) to display the superimposable content control 155's display area 165 below the superimposable content control 155's image 160 and overlapping the image 160. As shown, the image 160 is located in the bottom portion of a page of the document 145 (e.g., at least half of the image 160 is positioned below a line that horizontally bisects the page) that is displayed in the display area 140 and the display area 165 is the same size as the display area 165 shown in FIG. 11. For this example, the location of the image 160 in the page, the size of the display area 165, and the size of the page prevents the document authoring application from displaying the display area 165 below the image 160 without overlapping the image 160 nor intersecting any of the sides of the page. Thus, the document authoring application displays the display area 165 below and overlapping the image 160 and without intersecting any of the sides of the page.

The above-described FIGS. 6-12 illustrate one technique that the document authoring application of some embodiments uses to determine a location to display the display area of a superimposable content control. Different embodiments use additional and/or other techniques. In some embodiments, the location at which the document authoring application displays the display area of a superimposable content control in the document is an approximation of the location a document viewing application might display the display area. In other words, the location that the document authoring application displays the superimposable content control's display area in a document may not be the same exact location that a document viewing application displays the display area as different hardware, display sizes, etc., on which document viewing applications operate may limit the document viewing applications from displaying the display area in the same exact location. In addition, the document viewing application of some embodiments uses different techniques for determining the location at which to display the display area of the superimposable content control.

Many of the figures described above illustrate various examples of a superimposable content control that is part of a document being authored as presented by the document authoring application of some embodiments. In some embodiments, the corresponding functionality and appearance of the example superimposable content controls as presented by a document viewing application of some embodiments is similar to that described above by reference to FIG. 2. For instance, the relative location of a superimposable content control's selectable image provided by the document viewing application of some embodiments is the same or similar to the location displayed by the document authoring application in the examples described above. Similarly, the location of a superimposable content control's display area that a document viewing application of some embodiments superimposes over other content being displayed when a user selects the superimposable content control's image is the same or similar to the location of the superimposable content control's display area displayed by the document authoring application in the examples described above.

### II. Scrollable Content Controls

As mentioned above, the document authoring application of some embodiments provides a novel content control tool that includes a selectable UI item that a user selects to insert a scrollable content control into the document being authored. A scrollable content control of some embodiments (1) includes a display area for displaying the content control's content separate from other content in the document and (2) provides a scrolling feature that allows the user to adjust the portion of the content control's content that is displayed in the display area when the content cannot be displayed in the display area all at once.

A. Adding Media Content

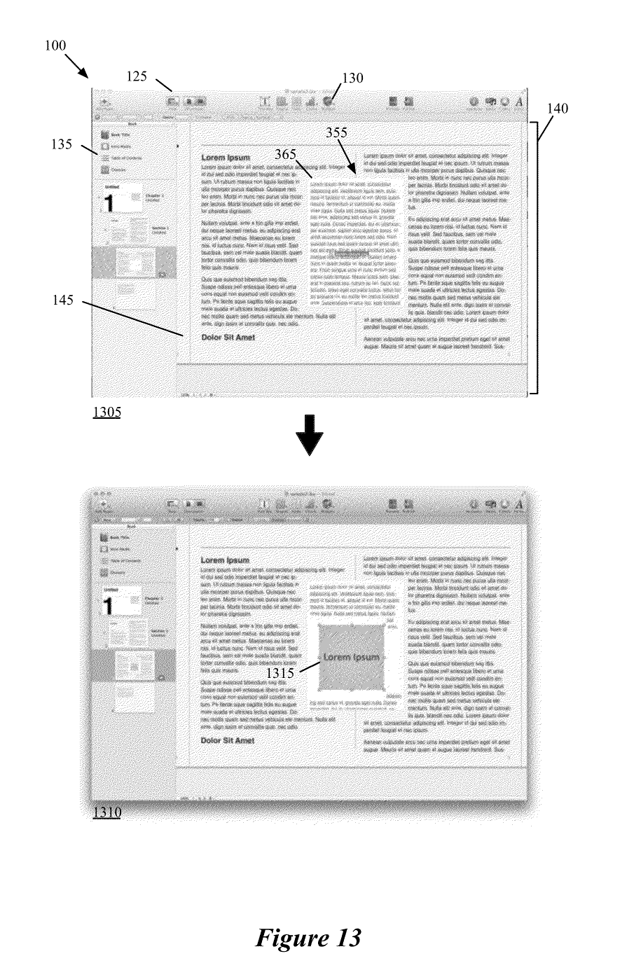

As explained above, the document authoring application of some embodiments allows a user to specify various types of content for a scrollable content control. FIG. 13 conceptually illustrates adding media content to scrollable content control according to some embodiments of the invention. In particular, FIG. 13 illustrates the GUI 100 at two different stages 1305 and 1310 of adding an image 1315 to the scrolling content control 355 according to some embodiments of the invention.

The first stage 1305 of the GUI 100 is similar to the fourth stage 320 described above by reference to FIG. 3. That is, the first stage 1305 illustrates the GUI 100 after a user has specified content for the scrollable content control 355. In particular, the user has added textual content to the display area 365.

In addition, the first stage 1305 illustrates that the user is specifying media content for the scrollable content control 355. For this example, the user is adding an image 1315 to the display area 365. Specifically, the user has selected a graphical representation of the image 1315 in a folder structure (not shown in FIG. 13) of an operating system on which the document authoring application is operating using a cursor (e.g., by performing a drag-and-drop cursor operation such as clicking and holding a mouse button, touching and dragging across a touchscreen, etc.) and placing a graphical representation of the image over the scrollable content control 355's display area 365.

The second stage 1310 illustrates the GUI 100 after the document authoring application has added the image 1315 to the display area 365. When the document authoring application of some embodiments receives a completion of the user's input while the graphical representation of the image 1315 is positioned over the display area 365, the document authoring application inserts the image 1315 into the content layout through the display area 365. In some embodiments, the document authoring application reduces the size of the image 1315 when the image exceeds a defined dimension or set of dimensions (e.g., width, height, etc.) while maintaining the aspect ratio of the image. When the image does not meet a defined minimum dimension or set of dimensions, the document authoring application of some embodiments enlarges the size of image 1315 while maintaining the aspect ratio of the image.

In some embodiments, the document authoring application allows a user to adjust the size of image content in a scrollable content control's display area. For example, when the document authoring application of some embodiments receives a selection of the scrollable content control's display area, the document authoring application presents (e.g., overlays) a set of adjustable UI controls (e.g., square-shaped adjustment handles) for adjusting the size of the display area. Referring to FIG. 13 as an example, the second stage 1310 illustrates the document authoring application of some embodiments overlaying a set of adjustable UI controls for adjusting the size of the scrollable content control's display area 365. As shown in the first stage 1310, an adjustable UI control is overlaid at each corner of the display area 365 and an adjustable UI control is overlaid along each side of the display area 365. In some embodiments, the user adjusts the size of the display area 365 by selecting and moving an adjustable UI control (e.g., by clicking-and-holding a mouse button and dragging the mouse, tapping a touchpad and dragging across the touchpad, or touching with a finger the adjustable UI control displayed on a touchscreen and dragging the finger across the touchscreen) in order to adjust the size of the display area 365 along a direction (e.g., up, down, left, right, diagonal, etc.).

B. Adjusting the Content Layout

As noted above, in some embodiments, the document authoring application provides a scrolling feature for a scrollable content control that allows the user to adjust the portion of a content control's content layout that is displayed in the content control's display area when the content layout cannot be displayed in the display area all at once. For instance, the scrolling feature of some embodiments allows the user to move the content layout (e.g., scroll in a vertical direction, scroll in a horizontal direction, etc.) with respect to the scrollable content control's display area in order to adjust the portion of the content layout that is displayed in the display area.

In some embodiments, the document authoring application automatically adjusts the size of the content layout when content is added to the content layout, moved within the content layout, and removed from the content layout. For instance, as a user is adding textual content (e.g., by providing input through a keyboard, a virtual keyboard, etc.) and content in the content layout passes a threshold boundary, the document authoring application increases the size of the content layout (e.g., increasing the vertical length of the defined area of the content layout) to provide space for the added content.

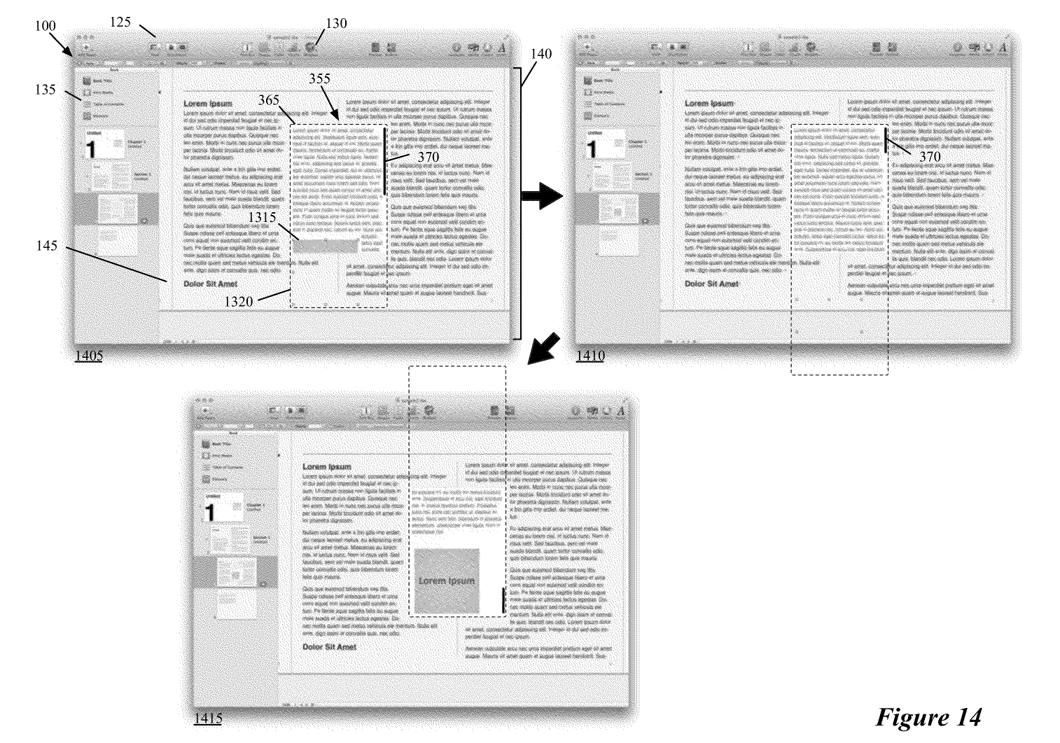

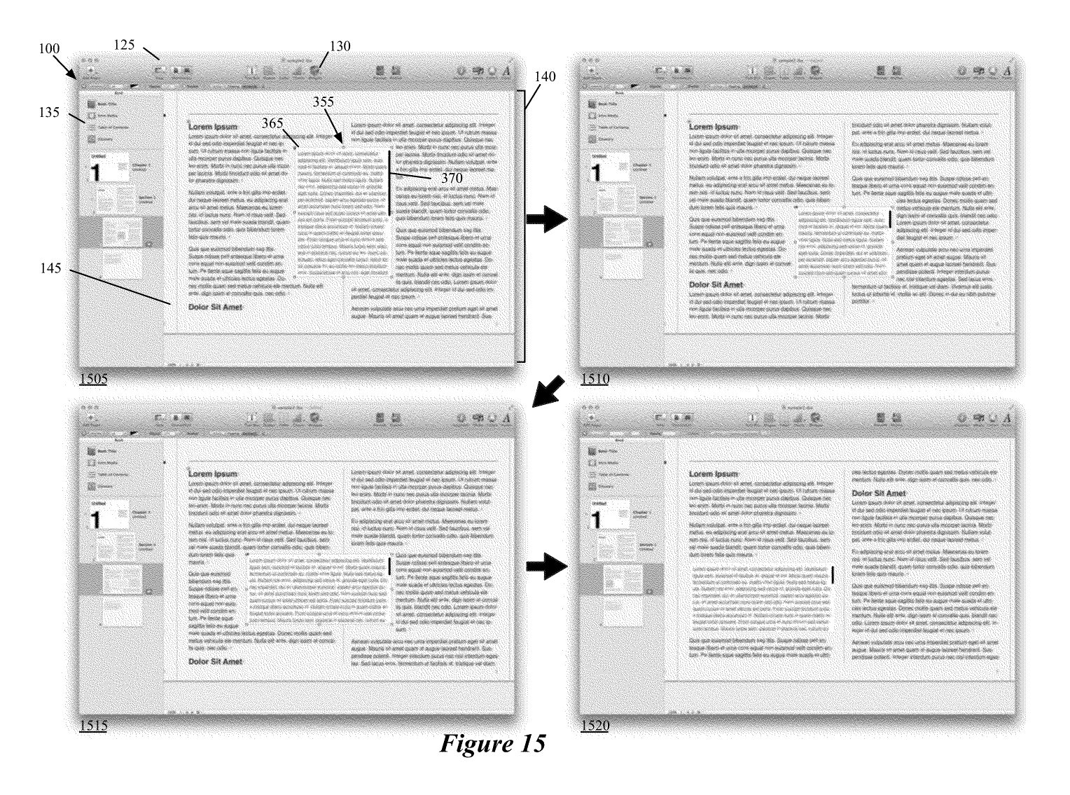

FIG. 14 conceptually illustrates an automatic layout-resizing feature of a scrollable content control according to some embodiments of the invention. Specifically, FIG. 14 illustrates the GUI 100 at three different stages 1405-1415 of moving the image 1315 within a content layout 1320 displayed through the display area 365 of the scrollable content control 355. As mentioned above, the content layout of some embodiments is a description of an arrangement of content in a defined area. As shown, the defined area of the content layout 1320 is indicated by a dashed rectangle and the display area 365 is displaying only a portion of the content layout 1320. One of ordinary skill in the art will realize that the dashed rectangles illustrated in FIG. 14 are, in some embodiments, conceptualizations of the content layout of a scrollable content control that are shown for purposes of explanation and that the document authoring application of some such embodiments does not actually display the dashed rectangles.

The first stage 1405 of the GUI 100 continues from the second stage 1310 described above by reference to FIG. 13. In this example, the user is moving the image 1315 downwards within the content layout 1320. Specifically, the user in this example used a cursor to select the image 1315 (e.g., by performing a drag-and-drop cursor operation such as clicking and holding a mouse button, touching and dragging across a touchscreen, etc.) and is dragging the image 1315 in a downward direction in order to move the image 1315 towards the bottom of the content layout 1320. As shown, the image 1315 has moved farther down towards the bottom of the content layout 1320 compared to the position of the image 1315 illustrated in the second stage 1310 shown in FIG. 13.

The first stage 1405 also illustrates a set of adjustable UI controls overlaying the image 1315 to indicate the position of the image 1315. In some embodiments, the document authoring application continuously displays the set of adjustable UI controls about the image 1315 while the user is moving the image 1315 in order to provide feedback to the user indicating the position of the image 1315 in the content layout 1320.

The second stage 1410 illustrates the GUI 100 after the user finished moving the image 1315. As shown, the set of adjustable UI controls overlaying the image 1315 indicates that the image 1315 is at or near the bottom of the content layout 1320. In addition, the second stage 1410 shows that the content layout 1320 increased in size in response to the movement of the image 1315.

In some embodiments, the document authoring application automatically increases the size of the content layout 1320 a defined amount when the document authoring application detects that content in the content layout 1320 passes a defined boundary within the content layout 1320. For this example, the document authoring application increased the size of the content layout 1320 by extending the bottom of the content layout 1320 as the user was moving the image 1315 downwards near the bottom of the content layout 1320.

In conjunction with adjusting the size of the content layout, the document authoring application of some embodiments automatically adjusts the size of a scroll indicator if the size of the content layout is larger than the size of the display area of the scrollable content control. As illustrated in the second stage 1410, the document authoring application has decreased the vertical length of the scroll indicator 370 in response to the increased vertical length of the content layout 1320.

The third stage 1415 shows the GUI 100 after the user adjusted the portion of the content layout 1320 displayed through the display area 365 of the scrollable content control 355.

Specifically, the user for this example has provided scroll input (e.g., providing direction arrow input through a keyboard, rotating a scroll wheel of a mouse, etc.) while a cursor is positioned within the display area 365 to scroll to the bottom of the content layout 1320, as indicated by the position of the scroll indicator 370. As shown, the image 1315 is positioned at or near the bottom of the content layout 1320. When the document authoring application of some embodiments receives the scroll input, the document authoring application moves the content layout 1320 upwards with respect to the display area 365.

In some embodiments, the document authoring application of some embodiments prevents the size of the content layout from extending past a defined maximum size. For example, the document authoring application of some embodiments prevents the vertical length of the content layout from extending past a defined maximum length. Alternatively or in conjunction with limiting the vertical length of a content layout, the document authoring application prevents the horizontal length of the content layout from extending past a defined maximum length.

C. Adjusting the Display Area

The document authoring application of some embodiments allows a user to adjust the size of the display area of a scrollable content control. FIG. 15 conceptually illustrates an example of resizing and moving a scrollable content control according to some embodiments of the invention. in particular, FIG. 15 illustrates the GUI 100 at four different stages 1505-1520 that show several resizing operations and a move operation performs on the scrollable content control 355 according to some embodiments of the invention.

The first stage 1505 is similar to the fourth stage 320 described above by reference to FIG. 3 except the content layout of the scrollable content control 355 contains additional content, as indicated by the scroll indicator 370 having a shorter vertical length. In some embodiments, the document authoring application presents (e.g., overlays) a set of adjustable UI controls (e.g., square-shaped adjustment handles) for adjusting the size of the display area of a scrollable content control when the document authoring application receives a selection of the display area. In this example, the user has selected the display area 365 (e.g., by performing a cursor operation such as clicking a mouse button, tapping a touchpad, or touching the UI item 130 displayed on a touchscreen, etc.) to invoke the display of the set of adjustable UI controls illustrated about the display area 365 in the first stage 1505. When the document authoring application of some embodiments receives the selection of the display area 365, the document authoring application overlays the set of adjustable UI controls over the display area 365.

The second stage 1510 illustrates the GUI 100 after the vertical length of the display area 365 is decreased. In this example, the user shortened the vertical length of the display area 365 by selecting and moving the adjustable UI control overlaid along the top side of the display area 365 (e.g., by clicking-and-holding a mouse button and dragging the mouse, tapping a touchpad and dragging across the touchpad, or touching with a finger the adjustable UI control displayed on a touchscreen and dragging the finger across the touchscreen) in a downward direction. As the display area 365 in the second stage 1510 displays less content of the content layout than the display area 365 illustrated in the first stage 1505, the document authoring application displays the scroll indicator 370 vertically shorter to appropriately indicate the increased distance to scroll from the top to the bottom of the content layout.

The third stage 1515 illustrates the GUI 100 after the horizontal length of the display area 365 is increased. For this example, the user lengthened the horizontal length the display area 365 by selecting and moving the adjustable UI control overlaid along the left side of the display area 365 (e.g., by clicking-and-holding a mouse button and dragging the mouse, tapping a touchpad and dragging across the touchpad, or touching with a finger the adjustable UI control displayed on a touchscreen and dragging the finger across the touchscreen) towards the left.

In some embodiments, the document authoring application adjusts the content layout of a scrollable content control when the size of the scrollable content control's display area is adjusted. The third stage 1515 shows that the document authoring application in this example adjusted the width of the content layout in response to the increased width of the display area 365 in order to utilize the additional space in the display area 365 for displaying content.

The fourth stage 1520 shows the GUI 100 after the scrollable content control 355 is moved within the document 145. The user for this example moved the scrollable content control 355 by selecting and moving the display area 365 of the content control 355 (e.g., by clicking-and-holding a mouse button and dragging the mouse, tapping a touchpad and dragging across the touchpad, or touching with a finger a location within the display area 365 displayed on a touchscreen and dragging the finger across the touchscreen) towards the left side of the page displayed in the display area 140.

C. Example Presentations of a Scrollable Content Control

The figures described above in this section show several examples of a scrollable content control that is part of a document being authored as presented by the document authoring application of some embodiments. In some embodiments, the corresponding functionality and appearance of the example scrollable content controls as presented by a document viewing application of some embodiments is similar to how the scrollable content control is presented by the document authoring application of some embodiments.

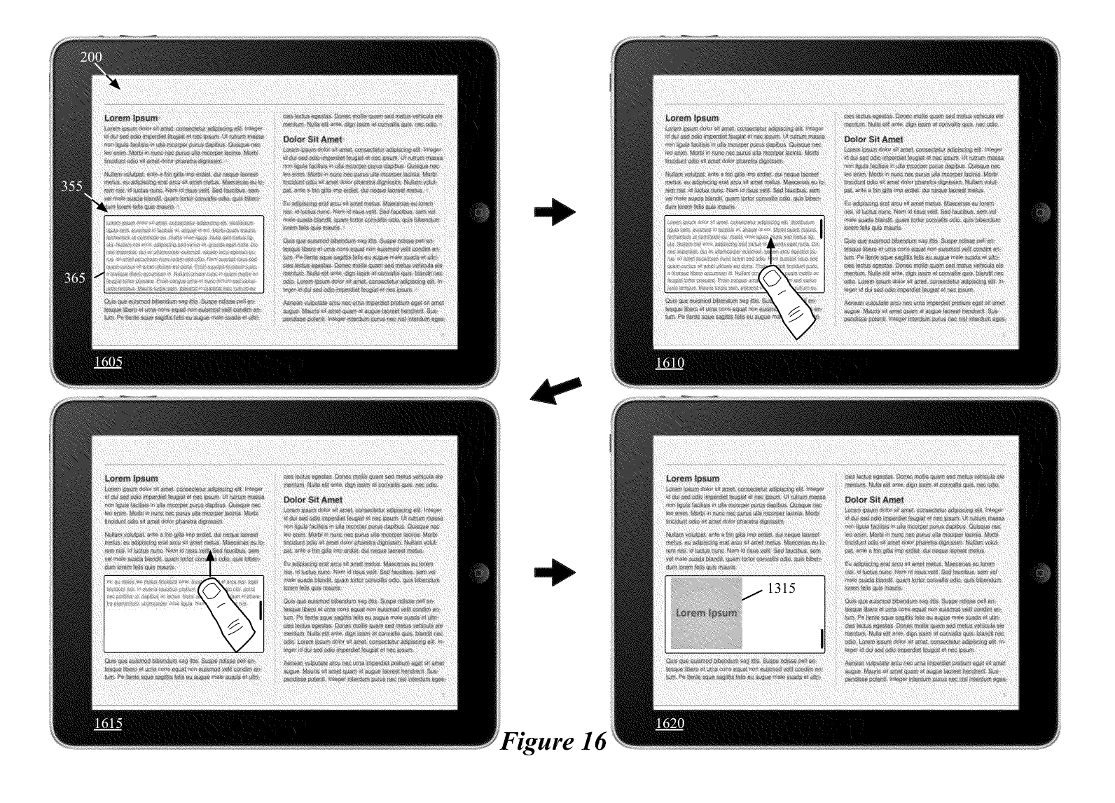

FIG. 16 conceptually illustrates the scrollable content control illustrated in FIG. 15 as presented by a document viewing application of some embodiments. Specifically, FIG. 16 illustrates the GUI 200 at four different stages 1605-1620 of viewing the content of the scrollable content control 355 illustrated in FIG. 15.

The first stage 1605 illustrates the GUI 200 displaying a portion of the document 145 that includes the scrollable content control 355. In this example, the document viewing application is presenting the scrollable content control 355 as the scrollable content control 355 is configured at the fourth stage 1520 illustrated in FIG. 15. As shown, the GUI 200 is displaying the display area 365 of the scrollable content control 355 in the left part of the page in a similar fashion as that illustrated in the fourth stage 1520 of FIG. 15.

The second stage 1610 illustrates the GUI 200 as a user begins scrolling the content layout displayed through the display area 365. For this example, the user is scrolling the content in an upward direction by touching a finger on the display area 365 displayed on the touchscreen and dragging the finger in an upward direction across the touchscreen. In some embodiments, when the document viewing application receives a touch input through the touchscreen of a location within the display area 365, the document viewing application displays the movable scroll indicator 370. As shown, the scroll indicator 370 is indicating (1) that content is scrollable in a vertical direction with respect to the display area 365 and (2) the portion of the display area 365's content that is displayed is at or near the beginning of the content layout.

The third stage 1615 the GUI 200 illustrates the user continuing to scroll the content layout through the display area 365. As shown, the user at this stage continues scrolling the content layout in an upward direction by continuing to touch the finger on the touchscreen and dragging the finger in an upward direction across the touchscreen. The scroll indicator 370 illustrated in the third sage 1615 is indicating (1) that the content layout is scrollable in a vertical direction with respect to the display area 365 and (2) the portion of the content layout that is displayed in the display area 365 is at or near the middle of the content layout.

The fourth stage 1620 shows the GUI 200 after the user finished scrolling the content layout to the end or near the end of the display area 365's content. For this example, the user finished scrolling the content by lifting the finger off the touchscreen. As illustrated, the scroll indicator 370 is indicating (1) that content is scrollable in a vertical direction with respect to the display area 365 and (2) the portion of the content layout displayed in the display area 365's is at or near the end of the content layout.

In some embodiments, the document viewing application provides different viewing modes for viewing documents. For instance, the document viewing application of some embodiments provides a landscape-viewing mode and a portrait-viewing mode. The landscape-viewing mode of some embodiments is for viewing documents when the display screen of a device on which the document viewing application operates is in a landscape orientation, the landscape-viewing mode is specified through settings on the device (e.g., a setting that specifies applications on the device to use a landscape-viewing mode regardless of the actual orientation of the device), etc. In some embodiments, the portrait-viewing mode is for viewing documents when the display screen of the device on which the document viewing application operates is in a portrait orientation, the portrait-viewing mode is specified through settings on the device (e.g., a setting that specifies applications on the device to use a portrait-viewing mode regardless of the actual orientation of the device), etc.

In some embodiments, the document viewing application displays many of the types of elements and constructs in documents in the same or similar fashion when the document viewing application is in a landscape-viewing mode or a portrait-viewing mode. The document viewing application of some embodiments displays some document elements and constructs differently depending on the viewing mode that is used to display the document elements and constructs.

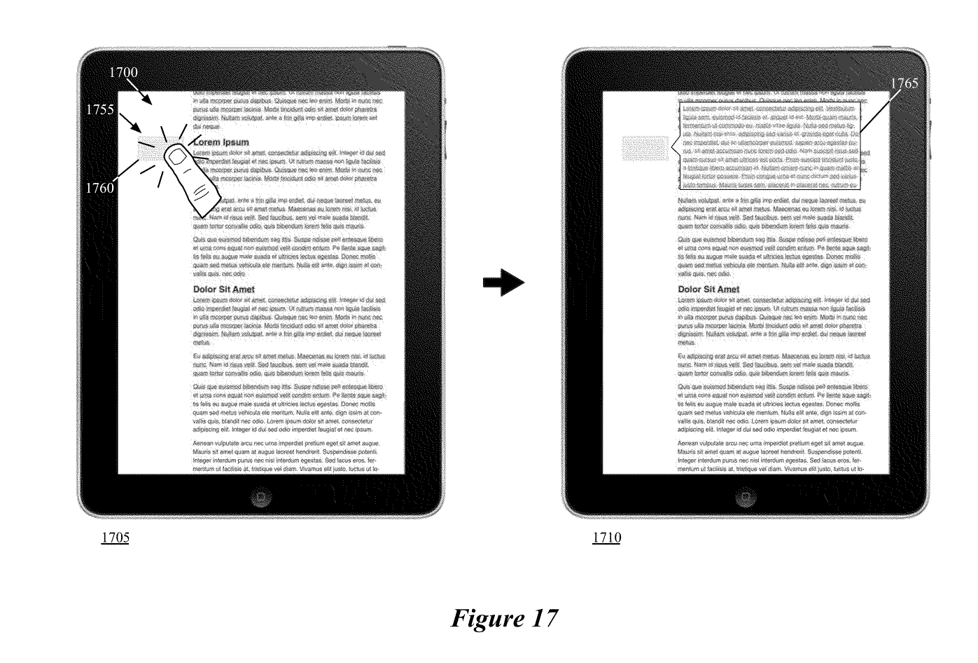

FIG. 17 conceptually illustrates the scrollable content control 355 illustrated in FIG. 15 as presented in a portrait-viewing mode by a document viewing application of some embodiments. Specifically, FIG. 17 illustrates a GUI 1700 at two different stages 1705 and 1710 of viewing the content of the scrollable content control 355 illustrated in FIG. 15 in a portrait-viewing mode. As shown, the GUI 1700 includes a main section on the right side for displaying contents of the document 345 and a sidebar section on the left side for displaying document constructs and/or other types of document elements.

The first stage 1705 illustrates the GUI 1700 displaying a portion of the document 345 that includes the scrolling content control 355 in a portrait-viewing mode. In some embodiments, the document viewing application presents a scrolling content control in a portrait-viewing mode as a superimposable content control in the sidebar section of the GUI 1700. As shown in the first stage 1705, the GUI 1700 is displaying the scrollable content control 355 as a superimposable content control 1755 in the sidebar section on the left side of the GUI 1700.

In some embodiments, the document viewing application generates and specifies a thumbnail image of the scrollable content control 355 as presented in a landscape-viewing mode by the document viewing application (the scrollable content control 355 as illustrated in the first stage 1605 of FIG. 16 in this example), as the selectable image 1760 of the superimposable content control 1755. The document viewing application of some embodiments specifies the superimposable display area of the content control 1755 to appear the same or similar to the display area 365 of the scrollable content control 355 as presented in a landscape-viewing mode by the document viewing application (the scrollable content control 355 as illustrated in the first stage 1605 of FIG. 16 in this example).

The first stage 1705 also shows that a user is selecting the image 1760 to invoke the display of the superimposable display area of the superimposable content control 1755. Here, the user is selecting the image 1760 by touching a finger on the image 1760 displayed on the touchscreen. When the document viewing application receives the selection of the image 1760, the document viewing application of some embodiments displays the superimposable content control 1755's display area 1765 by superimposing the display area 1765 over other content displayed in the display area GUI 1700.

The second first stage 1710 illustrates the GUI 1700 after the image 1760 has been selected to invoke the display of the superimposable display area 1765 of the content control 1755. The superimposable display area 1765 is displayed over the other content displayed in the display area 225.

### III. Data Structures for Content Controls

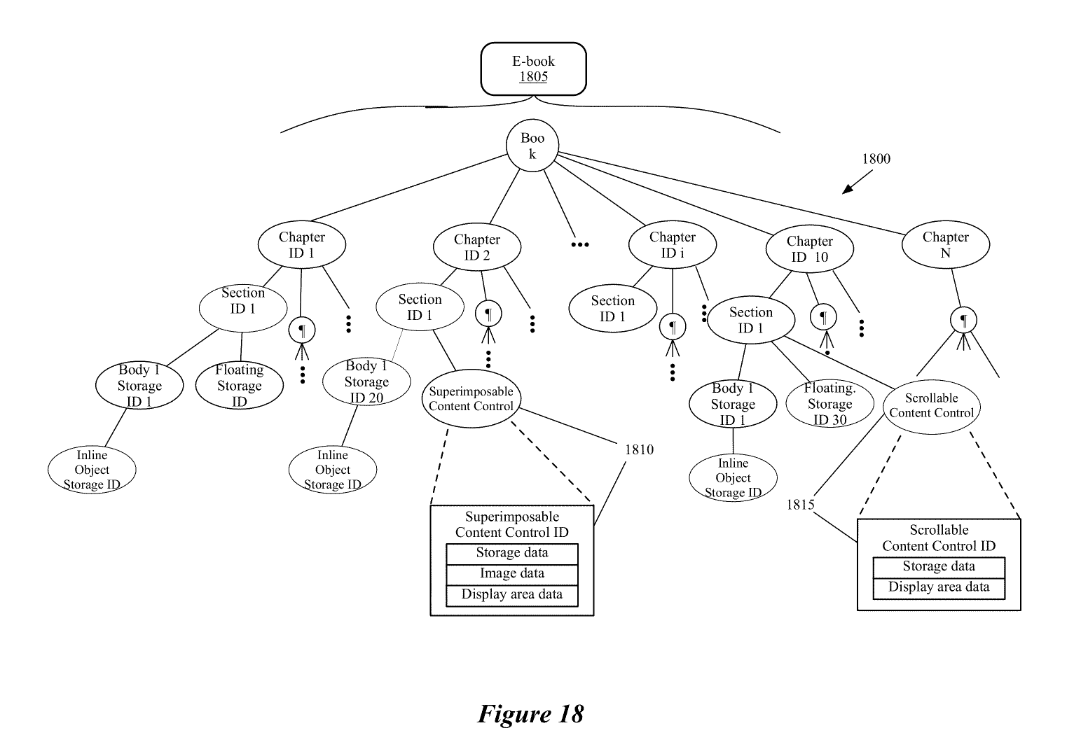

In some embodiments, the document authoring application uses a hierarchal data structure for efficiently storing and accessing document data. FIG. 18 conceptually illustrates a hierarchical data structure 1800 for representing a structured electronic document. FIG. 18 also illustrates a superimposable content control data structure 1810 and a scrollable content control data structure 1815 and their relationship to the hierarchical tree structure 1800.

The hierarchical data structure illustrated in FIG. 18 is a tree structure 1800 that contains multiple levels of different nodes that correspond to different levels of organization within the document. FIG. 18 illustrates that in some embodiments the document is an electronic book 1805 that is organized in a hierarchical tree structure 1800 based on chapters and sections. Each section includes a body layer and one or more floating layers.

As illustrated, each chapter node contains one or more section child nodes, which provide the next level of nodes within the tree structure. Each section node includes a body child node and one or more floating child nodes, which provide another level of nodes within the tree structure. Lastly, each body node includes an inline child node.

Each of the body nodes, floating nodes, and inline nodes may be used as a storage node to store content segments within the electronic document 1805. The content segment sets can include (1) any text string, (2) one or more images, other audio/video content segments, or other type of content data, and/or (3) any combination of such content segments.

In some embodiments, each storage has an associated identifier, or unique Storage ID, that uniquely identifies the storage. In some embodiments, this Storage ID may be a Globally Unique Identifier, or GUID, within the document. The GUID is a unique identifier that is used to identify a particular storage within the document. In addition, each storage node may be identified within the hierarchical tree structure 1800 using the location information. In particular, each storage node can be uniquely specified in terms of the chapter ID, section ID, and either as body ID, floating ID, or inline ID.

In some embodiments, content can be defined within both the body layer and the floating layer. Content in the body layer is placed “in line” (i.e., two pieces of content cannot overlap in the body layer) in some embodiments. In contrast, content within the floating layer can overlap with other content within the floating layer. In other words, content in the floating layer may occlude other content in this layer. Consequently, in these embodiments, adding new content or dragging existing content within the floating layer may result in overlapped content.

Content in the floating layer is not affected by content in the body layer of the document. Content in either the floating or body layer can be replaced with new content without affecting content in the other layer. Thus, the floating object nodes exist within a section of the document independent of the body object nodes. In particular, the body object nodes typically have a relationship to other body object nodes, such as a sequential or in-line relationship, in some embodiments.

FIG. 18 illustrates an example of a superimposable content control data structure 1810 of some embodiments for representing a superimposable content control. In some embodiments, the document authoring application creates and stores the superimposable content control data structure 1810 as part of a tree structure 1800 for each instance of a superimposable content control. In this example, the superimposable content control represented by the superimposable content control data structure 1810 is defined as a floating object (e.g., a floating control). As such, the superimposable content control data structure 1810 is defined as a child node of a section node in the tree structure 1800.

As shown, the superimposable content control data structure 1810 includes storage data, image data, and display area data. The image data includes an image file or a reference to an image file that the document authoring application uses as the selectable graphical representation in a document. The image data also includes the size of the image. In some embodiments, the document authoring application stores a default image at a default size for a superimposable content control when the document authoring application creates the content control. The document authoring application replaces and/or modifies the image data when a user specifies an image for the superimposable content control or adjusts the size of the image.

The display area data stores the size of the display area of the superimposable content control. As described above by reference to FIG. 6, the document authoring application of some embodiments uses the size of the image and the size of the display area to determine a location at which to display the display area when a user invokes the display of the display area. When a user adjusts the size of a scrollable content control, the document authoring application performs a corresponding modification to the display data.

In some embodiments, the storage data stores content (e.g., text, still images, etc.) specified for the superimposable content control as well as a content layout that describes the arrangement of the specified content in a defined area. The content layout is stored as a hierarchical data structure that is similar to a section described above. That is, the content layout can include a body child node and one or more floating child nodes, and the body node can include one or more an inline child nodes. In some embodiments, the document authoring application displays the content layout through the display area when the display area is invoked for display.

FIG. 18 also illustrates an example of a scrollable content control data structure 1815 of some embodiments for representing a scrollable content control. The document authoring application of some embodiments creates and stores the scrollable content control data structure 1815 as part of a tree structure 1800 for each instance of a scrollable content control. The scrollable content control in this example that is represented by the scrollable content control data structure 1815 is defined as a floating object (e.g., a floating control). Thus, the scrollable content control data structure 1815 is defined as a child node of a section node in the tree structure 1800.

As illustrated, the scrollable content control data structure 1815 includes storage data and display area data. The display area data stores the size of the display area of the scrollable content control. In some embodiments, the document authoring application displays the display area for the scrollable content control according to the size of the display area. The storage data of some embodiments stores content (e.g., text, still images, etc.) specified for the scrollable content control and a content layout that describes the arrangement of the specified content in a defined area. The content layout is stored as a hierarchical data structure that is similar to a section described above. Specifically, the content layout can include a body child node and one or more floating child nodes, and the body node can include one or more an inline child nodes. The document authoring application of some embodiments displays the content layout through the display area.

While FIG. 18 illustrates examples of a superimposable content control and a scrollable content control that are defined as floating objects, the document authoring application of some embodiments allow one or both of the types of content controls to be created as inline objects or modified from a floating object to an inline object. Similarly, in some embodiments, the document authoring application allows superimposable content controls and scrollable content controls to be modified from inline objects to floating objects.

In addition, the document authoring application of some embodiments allows a user to create a content control as an anchored object or convert a content control object (e.g., an inline object, a floating object, etc.) to an anchored object. An anchored object, in some embodiments, is associated with content (e.g., a word, a sequence of words, a set of words, an image, a content control, etc.) in a document. In some embodiments, the anchored object is defined to be displayed on the same page as the content with which the anchored object is associated. The anchored object of some such embodiments is displayed in the same relative location of a page regardless of the actual page on which the anchored object and its associated content is displayed. For instance, a scrollable content control might be created as an anchored object that is associated with a particular word in a document and the scrollable content control is specified to be display in the lower right corner of a page. Such a scrollable content control would always be displayed on the same page as the particular word and would always be displayed in the lower right corner of the page. For instance, if the particular word is located on page five of the document, the scrollable content control would be displayed in the lower right corner of the fifth page of the document. If content is added to the beginning of the document causing the particular word to move to page fifteen of the document, the scrollable content control would follow the particular word and would be displayed in the lower right corner of the fifteenth page of the document.

When creating a content control for a document, the document authoring application of different embodiments creates the content control as different objects in the document. For instance, in some embodiments, the document authoring application creates a content control as an anchored object when the content control is added to a section of the document with content (e.g., textual content) in it and automatically anchors to content at the beginning of the section (e.g., the first word, line, paragraph of the section). The document authoring application of some embodiments creates a content control as a floating object when the content control is added to portion of the document without any content (e.g., a blank page) in it.

In some embodiments, the document authoring application allows a user to add a superimposable content control to any document construct or element or convert the document construct or element (e.g., a body of text, a shape, a text box, a table, a chart, an image, etc.) to a superimposable content control. To add a superimposable content control or convert a document construct or element to a superimposable content control, the document authoring application of some embodiments creates a data structure similar to the superimposable content control data structure 1810 described above to represent the superimposable content control. In some embodiments, the document authoring application uses the document construct or element, or a thumbnail image of it, as the selectable image that represents the superimposable content control in the document.

As an example, the document authoring application of some embodiments allows the user to add a superimposable content control to a still image in a document by selecting the image and invoking a command (e.g., using a hotkey, a keystroke, a series of keystrokes, a combination of keystrokes, an option from a pull-down menu or a pop-up menu, etc.) to add a superimposable content control to the still image. In some embodiments, the document authoring application uses the still image as the selectable image that represents the superimposable content control in the document.

### IV. Exemplary Document Authoring Application

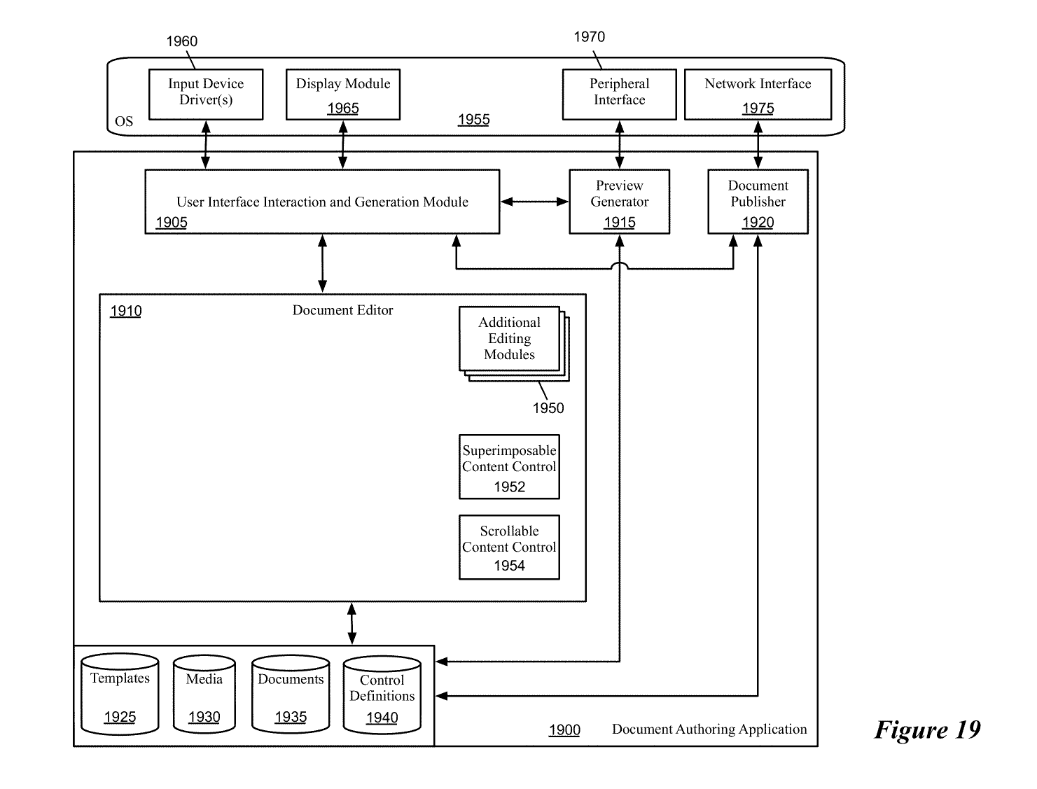

In some embodiments, the processes described above are implemented as software running on a particular machine, such as a computer or a handheld device, or stored in a machine-readable medium. FIG. 19 conceptually illustrates the software architecture of a document authoring application 1900 of some embodiments. In some embodiments, the document authoring application is a stand-alone application or is integrated into another application, while in other embodiments the application might be implemented within an operating system. Furthermore, in some embodiments, the application is provided as part of a server-based solution. In some such embodiments, the application is provided via a thin client. That is, the application runs on a server while a user interacts with the application via a separate machine remote from the server. In other such embodiments, the application is provided via a thick client. That is, the application is distributed from the server to the client machine and runs on the client machine.

The document authoring application 1900 includes a user interface (UI) interaction and generation module 1905, a document editor 1910, a preview generator 1915, and a document publisher 1920. The figure also illustrates stored data associated with the document authoring application, including templates 1925, media 1930, documents 1935, and control definitions 1940.

In some embodiments, the templates data 1925 stores template files that define different types of documents a user can create with the document authoring application 1900. The media data 1930 stores various types of media files (e.g., still image files, video files, audio files, combined video and audio files, etc.) imported into the application. The documents data 1935 of some embodiments stores user-created documents that may incorporate or refer to media 1930 and templates 1925. In some embodiments, the documents 1935 are stored by the document authoring application as hierarchical structures (e.g., organized into chapters, sections, etc.). The control definitions 1940 of some embodiments stores definitions for different types of controls (e.g., a superimposable content control, a scrollable content control, an audio and/or video control, a still photo collection control, etc.) that may be created and added to documents.

In some embodiments, the four sets of data 1925-1940 are stored in one physical storage (e.g., an internal hard drive, external hard drive, etc.). In some embodiments, the data may be split between multiple physical storages. For instance, the template files 1925 and media files 1930 might be stored in one physical storage, while the user-created documents and the control definitions 1940 are stored in a separate physical storage. In addition, some or all of the data 1925-1940 may be stored across multiple physical storages in some embodiments.

FIG. 19 also illustrates an operating system 1955 that includes input device driver(s) 1960, display module 1965, peripheral interface 1970, and network interface 1975. In some embodiments, as illustrated, the device drivers 1960, display module 1965, peripheral interface 1970, and network interface 1975 are part of the operating system even when the document authoring application 1900 is an application separate from the operating system.

The input device drivers 1960 may include drivers for translating signals from a keyboard, mouse, touchpad, tablet, touchscreen, etc. A user interacts with one or more of these input devices, which send signals to their corresponding device driver. The device driver then translates the signals into user input data that is provided to the UI interaction and generation module 1905.

The present application describes a graphical user interface that provides users with numerous ways to perform different sets of operations and functionalities. In some embodiments, these operations and functionalities are performed based on different commands that are received from users through different input devices (e.g., keyboard, trackpad, touchpad, mouse, etc.). For example, the present application illustrates the use of a cursor in the graphical user interface to control (e.g., select, move) objects in the graphical user interface. However, in some embodiments, objects in the graphical user interface can also be controlled or manipulated through other controls, such as touch control. In some embodiments, touch control is implemented through an input device that can detect the presence and location of touch on a display of the device. An example of such a device is a touch screen device. In some embodiments, with touch control, a user can directly manipulate objects by interacting with the graphical user interface that is displayed on the display of the touch screen device. For instance, a user can select a particular object in the graphical user interface by simply touching that particular object on the display of the touch screen device. As such, when touch control is utilized, a cursor may not even be provided for enabling selection of an object of a graphical user interface in some embodiments. However, when a cursor is provided in a graphical user interface, touch control can be used to control the cursor in some embodiments.

The display module 1965 translates the output of a user interface for a display device. That is, the display module 1965 receives signals (e.g., from the UI interaction and generation module 1905) describing what should be displayed and translates these signals into pixel information that is sent to the display device. The display device may be an LCD, plasma screen, CRT monitor, touchscreen, etc.

The peripheral 1970, in some embodiments, allows for a peripheral device to connect (either via a wired (e.g., USB, Firewire) connection or a wireless (e.g., Bluetooth, WiFi) connection) to the machine on which the operating system 1955 and document authoring application 1900 run. Examples of such peripheral devices may include smart phones (e.g., an iPhone), specialized electronic book readers, or more generic tablets (e.g., an iPad) that include electronic book reader functionality.

The network interface 1975 represents one or more connections to various types of networks, through which the document authoring application 1900 may upload published documents (e.g., to a content distribution system). These network connections may include WiFi or other wireless connections, Ethernet or other wired connections, etc.

The UI interaction and generation module 1905 of the document authoring application 1900 interprets the user input data received from the input device drivers and passes it to various modules, including the document editor 1910 and its various component modules, the preview generator 1915, and the document publisher 1920. The UI interaction module also manages the display of the document authoring application GUI, and outputs this display information to the display module 1965. This UI display information may be based on information from the document editor 1910, the document publisher 1920, etc. In addition, the module 1905 may generate portions of the UI based solely on user input—e.g., when a user moves an item in the UI that only affects the display rather than any of the other modules, such as moving a window from one side of the UI to the other. In some embodiments, the UI interaction and generation module 1905 generates a basic GUI and populates the GUI with information from the other modules and stored data (e.g., the document data 1935).

The document editor 1910 includes a superimposable content control module 1952, a scrollable content control module 1954, as well as additional editing modules 1950. The document editor 1910 enables a user to create documents (e.g., word processing documents, electronic books, etc.) with a variety of text, equations, media (e.g., audio, video), electronic book constructs (e.g., graphs, sidebars, popovers, etc.), and other features. In some embodiments, the document editor 1910 provides various panels of tools (e.g., through an inspector window) for editing attributes, enabling/disabling features, specifying format options, etc., of document elements and/or constructs (e.g., text boxes, shapes, content controls, etc.) and manages which of the tools are available for the numerous different document elements and/or constructs.

The document editor 1910, in some embodiments, provides operations that are common to, or operate across, some or all document elements and/or constructs. For example, in some embodiments, the document editor 1910 handles cut, copy, and paste operations of document elements and/or constructs. This allows, for instance, a user to create one or more copies of a particular configuration of a content control that the user wishes to add to the document.

The superimposable content control module 1952 provides superimposable content controls for a user to add a type of interactive content to documents. When the superimposable content control module 1952 receives a request for a superimposable content control (e.g., from the UI interaction and generation module 1905 through the document editor 1910), the superimposable content control module 1952 of some embodiments creates (e.g., instantiates) a superimposable content control based on content definitions in the content definitions 1940 and provides a default selectable image for the superimposable content control that represents the content control in a document. In some embodiments, the superimposable content control module 1952 handles edits to various attributes and/or properties of superimposable content controls (e.g., adding, modifying, and removing content, modifying the selectable image of superimposable content controls, adjusting the size of the selectable images, adjusting the size of the display area of superimposable content controls, etc.). In addition, the superimposable content control module 1952 of some embodiments manages the content specified for superimposable content controls and the content layout that describes the arrangement of the specified content in a defined area. The superimposable content control module 1952 of some embodiments determines the location at which a content control's superimposable display area is displayed when the display area is invoked.

The scrollable content control 1954 provides scrollable content controls for a user to add another type of interactive content to documents. When the scrollable content control module 1954 receives a request for a scrollable content control (e.g., from the UI interaction and generation module 1905 through the document editor 1910), the scrollable content control module 1954 of some embodiments creates (e.g., instantiates) a scrollable content control based on content definitions in the content definitions 1940. The scrollable content control module 1952 of some embodiments handles edits to numerous attributes and/or properties of scrollable content controls (e.g., adding, modifying, and removing content, adjusting the size of the display area of scrollable content controls, etc.). In some embodiments, the scrollable content control module 1952 is also manages the content specified for scrollable content controls and the content layout that describes the arrangement of the specified content in a defined area.

The additional editing modules 1950 enable various additional editing features. These features include formatting of electronic documents, addition of media and other constructs (e.g., graphs, sidebars, popovers, etc.) to electronic documents, spellchecking and other review features, etc.

The preview generator 1915 of some embodiments generates a preview of an electronic document (e.g., an electronic book) in order to allow a user to see how a document currently being edited will look in its final form. In some embodiments, the preview generator 1915 generates the preview of the document and sends this preview through the peripheral interface 1970 to an external electronic document reader device (e.g., a smart phone, a table computer, a specialized e-book reader, etc.). In addition, in some embodiments the document authoring application 1900 allows the user to preview the document through the application's user interface. The preview generator of some such embodiments can send the preview to the UI interaction and generation module 1905 for display in the authoring application user interface.

The document publisher 1920 of some embodiments generates a final version of an electronic document (e.g., an e-book in either a standardized or proprietary format) for sending out (e.g., via the network interface 1975) to a content distribution system. In some embodiments, the document publisher 1920 creates the electronic document and/or a sample version of the electronic document, and a separate application connects to the content distribution system in order to upload (publish) the document.

While many of the features of document authoring application 1900 have been described as being performed by one module (e.g., the UI interaction and generation module 1905, the document publisher 1920, etc.), one of ordinary skill in the art will recognize that the functions described herein might be split up into multiple modules. Similarly, functions described as being performed by multiple different modules might be performed by a single module in some embodiments (e.g., the preview generator 1915 might actually be part of the document publisher 1920).

### V. Electronic Systems

Many of the above-described features and applications are implemented as software processes that are specified as a set of instructions recorded on a computer readable storage medium (also referred to as computer readable medium). When these instructions are executed by one or more computational or processing unit(s) (e.g., one or more processors, cores of processors, or other processing units), they cause the processing unit(s) to perform the actions indicated in the instructions. Examples of computer readable media include, but are not limited to, CD-ROMs, flash drives, random access memory (RAM) chips, hard drives, erasable programmable read-only memories (EPROMs), electrically erasable programmable read-only memories (EEPROMs), etc. The computer readable media does not include carrier waves and electronic signals passing wirelessly or over wired connections.

In this specification, the term “software” is meant to include firmware residing in read-only memory or applications stored in magnetic storage which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

A. Mobile Device

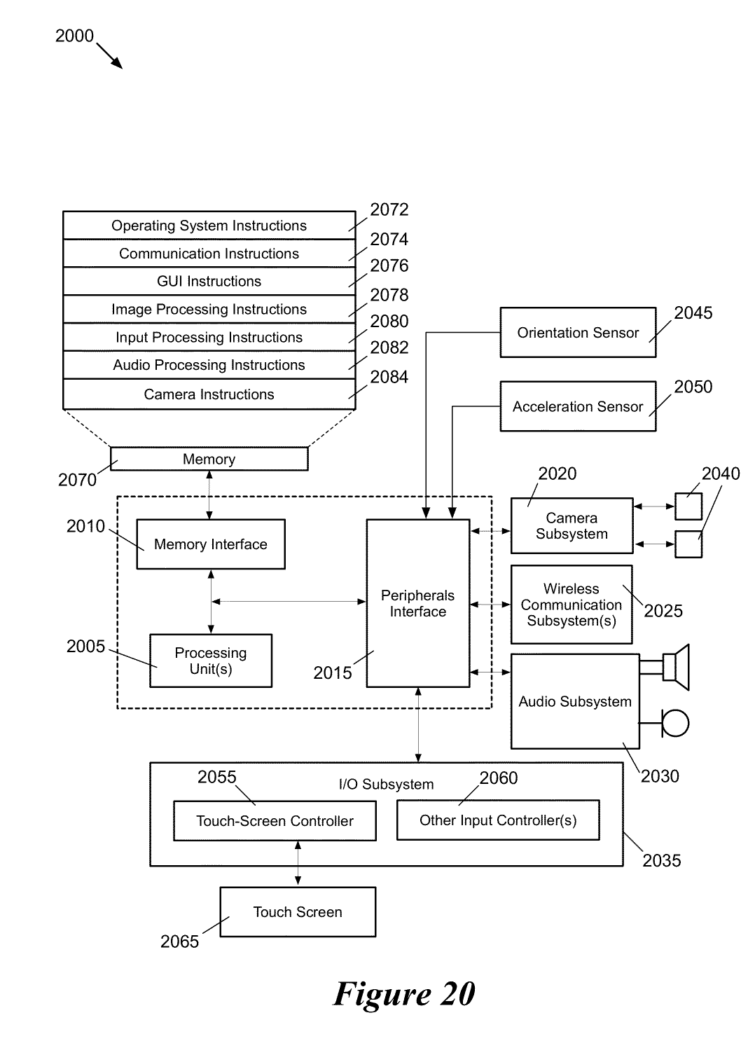

The document viewing application of some embodiments operate on mobile devices. FIG. 20 is an example of an architecture 2000 of such a mobile computing device. Examples of mobile computing devices include smartphones, tablets, laptops, etc. As shown, the mobile computing device 2000 includes one or more processing units 2005, a memory interface 2010 and a peripherals interface 2015.

The peripherals interface 2015 is coupled to various sensors and subsystems, including a camera subsystem 2020, a wireless communication subsystem(s) 2025, an audio subsystem 2030, an I/O subsystem 2035, etc. The peripherals interface 2015 enables communication between the processing units 2005 and various peripherals. For example, an orientation sensor 2045 (e.g., a gyroscope) and an acceleration sensor 2050 (e.g., an accelerometer) is coupled to the peripherals interface 2015 to facilitate orientation and acceleration functions.

The camera subsystem 2020 is coupled to one or more optical sensors 2040 (e.g., a charged coupled device (CCD) optical sensor, a complementary metal-oxide-semiconductor (CMOS) optical sensor, etc.). The camera subsystem 2020 coupled with the optical sensors 2040 facilitates camera functions, such as image and/or video data capturing. The wireless communication subsystem 2025 serves to facilitate communication functions. In some embodiments, the wireless communication subsystem 2025 includes radio frequency receivers and transmitters, and optical receivers and transmitters (not shown in FIG. 20). These receivers and transmitters of some embodiments are implemented to operate over one or more communication networks such as a GSM network, a Wi-Fi network, a Bluetooth network, etc. The audio subsystem 2030 is coupled to a speaker to output audio (e.g., to output different sound effects associated with different image operations). Additionally, the audio subsystem 2030 is coupled to a microphone to facilitate voice-enabled functions, such as voice recognition, digital recording, etc.

The I/O subsystem 2035 involves the transfer between input/output peripheral devices, such as a display, a touch screen, etc., and the data bus of the processing units 2005 through the peripherals interface 2015. The I/O subsystem 2035 includes a touch-screen controller 2055 and other input controllers 2060 to facilitate the transfer between input/output peripheral devices and the data bus of the processing units 2005. As shown, the touch-screen controller 2055 is coupled to a touch screen 2065. The touch-screen controller 2055 detects contact and movement on the touch screen 2065 using any of multiple touch sensitivity technologies. The other input controllers 2060 are coupled to other input/control devices, such as one or more buttons. Some embodiments include a near-touch sensitive screen and a corresponding controller that can detect near-touch interactions instead of or in addition to touch interactions.

The memory interface 2010 is coupled to memory 2070. In some embodiments, the memory 2070 includes volatile memory (e.g., high-speed random access memory), non-volatile memory (e.g., flash memory), a combination of volatile and non-volatile memory, and/or any other type of memory. As illustrated in FIG. 20, the memory 2070 stores an operating system (OS) 2072. The OS 2072 includes instructions for handling basic system services and for performing hardware dependent tasks.

The memory 2070 also includes communication instructions 2074 to facilitate communicating with one or more additional devices; graphical user interface instructions 2076 to facilitate graphic user interface processing; image processing instructions 2078 to facilitate image-related processing and functions; input processing instructions 2080 to facilitate input-related (e.g., touch input) processes and functions; audio processing instructions 2082 to facilitate audio-related processes and functions; and camera instructions 2084 to facilitate camera-related processes and functions. The instructions described above are merely exemplary and the memory 2070 includes additional and/or other instructions in some embodiments. For instance, the memory for a smartphone may include phone instructions to facilitate phone-related processes and functions. The above-identified instructions need not be implemented as separate software programs or modules. Various functions of the mobile computing device can be implemented in hardware and/or in software, including in one or more signal processing and/or application specific integrated circuits.

While the components illustrated in FIG. 20 are shown as separate components, one of ordinary skill in the art will recognize that two or more components may be integrated into one or more integrated circuits. In addition, two or more components may be coupled together by one or more communication buses or signal lines. Also, while many of the functions have been described as being performed by one component, one of ordinary skill in the art will realize that the functions described with respect to FIG. 20 may be split into two or more integrated circuits.

B. Computer System

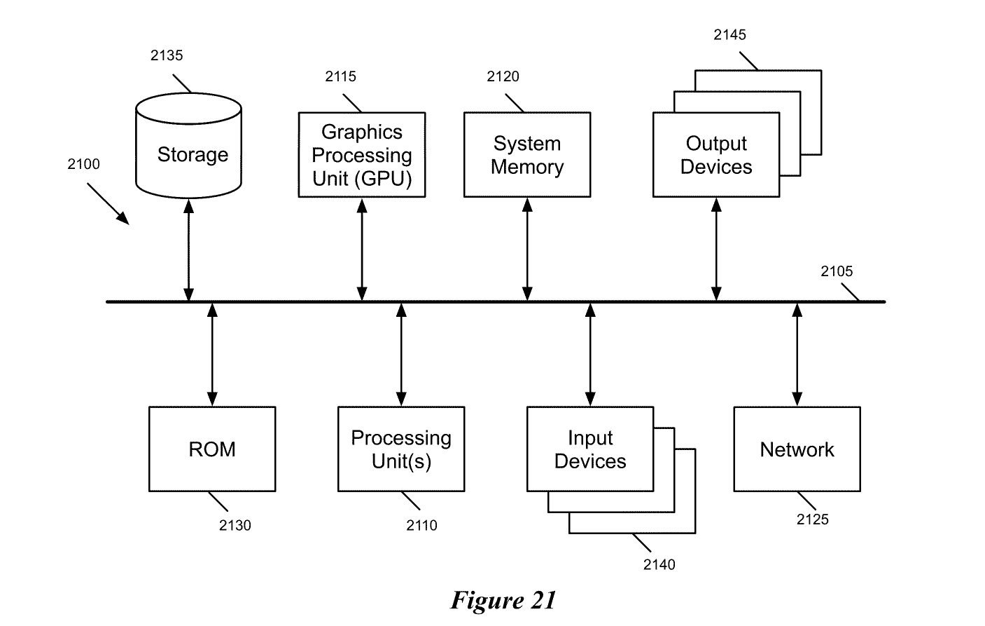

FIG. 21 conceptually illustrates an electronic system 2100 with which some embodiments of the invention are implemented. For instance, in some embodiments, the document authoring application described above by reference to FIGS. 1, 3, 5, and 7-15 are implemented by the electronic system 2100. The electronic system 2100 may be a computer (e.g., a desktop computer, personal computer, tablet computer, etc.), phone, PDA, or any other sort of electronic or computing device. Such an electronic system includes various types of computer readable media and interfaces for various other types of computer readable media. Electronic system 2100 includes a bus 2105, processing unit(s) 2110, a graphics processing unit (GPU) 2115, a system memory 2120, a network 2125, a read-only memory 2130, a permanent storage device 2135, input devices 2140, and output devices 2145.

The bus 2105 collectively represents all system, peripheral, and chipset buses that communicatively connect the numerous internal devices of the electronic system 2100. For instance, the bus 2105 communicatively connects the processing unit(s) 2110 with the read-only memory 2130, the GPU 2115, the system memory 2120, and the permanent storage device 2135.

From these various memory units, the processing unit(s) 2110 retrieves instructions to execute and data to process in order to execute the processes of the invention. The processing unit(s) may be a single processor or a multi-core processor in different embodiments. Some instructions are passed to and executed by the GPU 2115. The GPU 2115 can offload various computations or complement the image processing provided by the processing unit(s) 2110. In some embodiments, such functionality can be provided using CoreImage's kernel shading language.

The read-only-memory (ROM) 2130 stores static data and instructions that are needed by the processing unit(s) 2110 and other modules of the electronic system. The permanent storage device 2135, on the other hand, is a read-and-write memory device. This device is a non-volatile memory unit that stores instructions and data even when the electronic system 2100 is off. Some embodiments of the invention use a mass-storage device (such as a magnetic or optical disk and its corresponding disk drive) as the permanent storage device 2135.

Other embodiments use a removable storage device (such as a floppy disk, flash memory device, etc., and its corresponding drive) as the permanent storage device. Like the permanent storage device 2135, the system memory 2120 is a read-and-write memory device. However, unlike storage device 2135, the system memory 2120 is a volatile read-and-write memory, such a random access memory. The system memory 2120 stores some of the instructions and data that the processor needs at runtime. In some embodiments, the invention's processes are stored in the system memory 2120, the permanent storage device 2135, and/or the read-only memory 2130. From these various memory units, the processing unit(s) 2110 retrieves instructions to execute and data to process in order to execute the processes of some embodiments.

The bus 2105 also connects to the input and output devices 2140 and 2145. The input devices 2140 enable the user to communicate information and select commands to the electronic system. The input devices 2140 include alphanumeric keyboards and pointing devices (also called “cursor control devices”), cameras (e.g., webcams), microphones or similar devices for receiving voice commands, etc. The output devices 2145 display images generated by the electronic system or otherwise output data. The output devices 2145 include printers and display devices, such as cathode ray tubes (CRT) or liquid crystal displays (LCD), as well as speakers or similar audio output devices. Some embodiments include devices such as a touchscreen that function as both input and output devices.

Finally, as shown in FIG. 21, bus 2105 also couples electronic system 2100 to a network 2125 through a network adapter (not shown). In this manner, the computer can be a part of a network of computers (such as a local area network (“LAN”), a wide area network (“WAN”), or an Intranet, or a network of networks, such as the Internet. Any or all components of electronic system 2100 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application specific integrated circuits (ASICs) or field programmable gate arrays (FPGAs). In some embodiments, such integrated circuits execute instructions that are stored on the circuit itself. In addition, some embodiments execute software stored in programmable logic devices (PLDs), ROM, or RAM devices.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

While the invention has been described with reference to numerous specific details, one of ordinary skill in the art will recognize that the invention can be embodied in other specific forms without departing from the spirit of the invention. In addition, a number of the figures (including FIG. 6) conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the invention is not to be limited by the foregoing illustrative details, but rather is to be defined by the appended claims.

We claim:

1. A non-transitory machine-readable medium storing a document authoring application which when executed by at least one processing unit provides a graphical user interface (“GUI”) for the document authoring application, the GUI comprising:
a display area for displaying a document being authored; and
a document authoring tool for adding to the document a floatable content control comprising (1) a content display area for displaying content specified for the floatable content control and (2) a selectable user interface item (UI) that when selected causes the document authoring application to display the content display area,
the floatable content control for display by a document viewing application such that the document viewing application displays the specified content through the content display area when the document viewing application receives a selection of the UI item.

2. The non-transitory machine-readable medium of claim 1, wherein the document viewing application displays the content display area by superimposing the content display area over other content in the document that the document viewing application is displaying.

3. The non-transitory machine-readable medium of claim 1, wherein the content display area for specifying content for the floatable content control through the content display area.

4. The non-transitory machine-readable medium of claim 3, wherein specifying content for the floatable content control comprises adding content.

5. The non-transitory machine-readable medium of claim 3, wherein specifying content for the floatable content control comprises removing content.

6. The non-transitory machine-readable medium of claim 3, wherein specifying content for the floatable content control comprises modifying content.

7. The non-transitory machine-readable medium of claim 1, wherein the display area is further for receiving edits to the document through the display area.

8. The non-transitory machine-readable medium of claim 1, wherein the document authoring application presents a set of adjustable UI controls for adjusting a size of the content display area when the document authoring application receives a selection of the content display area.

9. The non-transitory machine-readable medium of claim 8, wherein the document authoring application presents the set of adjustable UI controls by overlaying the set of adjustable UI controls over the content display area.

10. The non-transitory machine-readable medium of claim 1, wherein the document authoring application presents a set of adjustable UI controls for adjusting a size of the selectable UI item when the document authoring application receives a selection of the selectable UI item.

11. The non-transitory machine-readable medium of claim 10, wherein the document authoring application presents the set of adjustable UI controls by overlaying the set of adjustable UI controls over the selectable UI item.

12. The non-transitory machine-readable medium of claim 1, wherein the selectable UI item is an image.

13. The non-transitory machine-readable medium of claim 12, wherein when the document authoring application receives a specification of a particular image through the selectable UI item, the document authoring tool replaces the image with the particular image

14. The non-transitory machine-readable medium of claim 1, wherein the document authoring application displays the content display area at a particular location in the display area based on the size of the selectable UI item and the size of the content display area.

15. A non-transitory machine-readable medium storing a document authoring application which when executed by at least one processing unit provides a graphical user interface (“GUI”) for the document authoring application, the GUI comprising:
a display area for displaying a document being authored; and
a document authoring tool for adding to the document a scrollable content control comprising (1) a content layout that describes an arrangement of content in a defined area and (2) a content display area for displaying a portion of the content layout through the content display area and receiving input to move the content layout with respect to the content display area in order to display different portions of the content layout through the content display area.

16. The non-transitory machine-readable medium of claim 15, wherein the scrollable content control further comprises a moveable scroll indicator for indicating that the content layout is scrollable with respect to the content display area along a particular direction with respect to the content display area.

17. The non-transitory machine-readable medium of claim 16, wherein the movable scroll indicator is further for indicating a location of the portion of the content layout that is displayed in the display area relative to the entire content layout.

18. The non-transitory machine-readable medium of claim 16, wherein the document authoring application displays the movable scroll indicator by overlaying the movable scroll indicator over content display area.

19. The non-transitory machine-readable medium of claim 15, wherein the document authoring application moves the content layout with respect to the content display area without moving the content display area.

20. The non-transitory machine-readable medium of claim 1, wherein the document authoring application presents a set of adjustable UI controls for adjusting a size of the content display area when the document authoring application receives a selection of the content display area.
